(19) United States
(12) Patent Application Publication
(10) Pub. No.: US 2026/0278246 A1
(43) Pub. Date: Sep. 17, 2026

(54) GENERATIVE RESPONSE ENGINE OUTPUTS BASED ON ORGANIZATIONAL CONTEXT

(71) Applicant: OpenAI OpCo, LLC, San Francisco, CA (US)

(72) Inventors: Dibyatanoy Bhattacharjee, San Francisco, CA (US); Uzair Navid Iftikhar, San Francisco, CA (US); Joshua Kaplan, San Francisco, CA (US); Yaming Lin, Palo Alto, CA (US)

(73) Assignee: OpenAI OpCo, LLC, San Francisco, CA (US)

(21) Appl. No.: 19/077,974

(22) Filed: Mar. 12, 2025

(51) Int. Cl. G06F 40/157; G06F 21/62

(52) U.S. Cl. CPC G06F 40/157; G06F 21/629

(57) ABSTRACT

The present technology is directed to generating output based on a context within an organization. For example, the present technology can use a generative response engine to provide responses to prompts based on meanings of terms that are specific to the organization or based on information included in content items of the organization. The present technology respects access privileges of the organization so that the generative response engine does not leak information within the organization to unauthorized members of the organization.

### BACKGROUND

Generative response engines such as large language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation. Generative response engines can sift through vast amounts of text data, extract context, and provide coherent responses to a wide array of queries.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

FIG. 1A illustrates an example system supporting a generative response engine during inference operations in accordance with some aspects of the present technology.

FIG. 1B and FIG. 1C illustrate the generative response engine interfacing with an organization server in accordance with some aspects of the present technology.

FIG. 2 illustrates a method for using a generative response engine to generate output based on an organizational context in accordance with some aspects of the present technology.

FIG. 3 illustrates a method for using a generative response engine to generate output based on a set of content items in accordance with some aspects of the present technology.

FIG. 4 illustrates an example routine for a layered approach to determining access to a content item in accordance with some aspects of the present technology.

FIG. 5 illustrates an example routine for determining when to access a content item to generate a response rather than to generate the response based on a chunk of the content item in a content item index in accordance with some aspects of the present technology.

FIG. 6 illustrates an example routine for indexing content items within the corpus of content items into a content item index in accordance with some aspects of the present technology.

FIG. 7 illustrates an example routine for identifying organizational vocabulary and recording it in an organizational vocabulary index in accordance with some aspects of the present technology.

FIG. 8 illustrates an example routine for learning user accounts, roles within the organization, access to content items, and organizational vocabulary to create or update a content item access index in accordance with some aspects of the present technology.

FIG. 9 illustrates an example routine for determining access privileges to a project for a user account in accordance with some aspects of the present technology.

FIG. 10A, FIG. 10B, FIG. 10C, and FIG. 10D illustrate example routines for training the generative response engine.

FIG. 11 is a block diagram illustrating an example machine-learning platform for implementing various aspects of this disclosure in accordance with some aspects of the present technology.

FIG. 12A, FIG. 12B, and FIG. 12C illustrate an example transformer architecture in accordance with some aspects of the present technology.

FIG. 13 shows an example of a system for implementing some aspects of the present technology.

### DETAILED DESCRIPTION

Various aspects of the disclosure are discussed in detail below. While specific implementations are discussed, it should be understood that this is done for illustration purposes only. A person skilled in the relevant art will recognize that other components and configurations may be used without parting from the spirit and scope of the disclosure.

Generative response engines such as large language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation. However, despite their remarkable linguistic prowess, these generative response engines ultimately output text based on statistical probabilities, as opposed to explicit understanding. While the output of generative response engines is often very good, this is the result of the very good answer being probable based on the input. But outputs that are often very good are not sufficient in some circumstances. Further, generative response engines have a goal of providing an answer and may not always recognize when it is appropriate to provide a refusal, or no output. For example, a refusal can be an appropriate output if a generative response engine does not have access to sufficient information from which to generate appropriate output in response to particular input.

Additional challenges are presented when implementing generative response engines in an organizational setting. For example, an organization can have a unique vocabulary or lexicon due to internal use of code names for projects, unique names for internal roles and responsibilities, unique names for conference rooms and meeting spaces, among others. Internal terms can therefore have meanings different from their plain language meaning. For example, an internal project can have a code name “Phoenix,” which refers to the particular project, rather than the mythical bird or the city in Arizona. A generative response engine should be able to disambiguate organizational vocabulary such that it can provide accurate output that is relevant to a prompt from a user account that is requesting information specific to or internal to an organization.

Another unique challenge when implementing generative response engines at an organizational level is that different user accounts may have different roles and different levels of access to stored content items. For example, a user account associated with an attorney for the organization may desire different information in response to a prompt for information about a project than a user account associated with an accountant for the organization. Both user accounts may prompt a generative response engine for “a summary of the status of project X.” Systems and methods disclosed herein facilitate tailored responses based on a type or role of a user account.

Further, user accounts within an organization may be associated with different permissions or different levels of access for different projects. As an example, a project having a particular code name may only be known within the organization to those user accounts directly involved with the project. Thus, disclosed systems and methods provide for a generative response engine that can determine a user account's permissions, thereby avoiding revealing information that the user account does not have access to. This information can include, in some examples, the existence of a code name or project within the organization. Disclosed aspects provide systems and methods for ensuring that a generative response engine does not improperly reveal the existence of restricted information to a user account that does not have access to the restricted information. In such a case, the generative response engine can be trained to provide a refusal indicating that the generative response engine does not have sufficient information to provide a response.

The present technology aims to address these and other challenges associated with generating output tailored to an organization or a user account associated with an organization from a generative response engine. For example, the present technology addresses the accuracy of the generative response engine in providing a response specific to an organization and the organization's internal terminology and phraseology. This can enable the generative response engine to recognize when a word is associated with a term in an organization's vocabulary and provide a response appropriately. For example, the generative response engine can recognize, based on a prompt, that a user account is requesting information associated with a project based on a code name of the project, where the code name may also have a plain language meaning outside the organization. Thus, the generative response engine can be used to request information associated with a project having a code name that may have a different meaning outside the organization. The generative response engine can provide tailored answers based on the corpus of content items associated with the organization on which it was trained and by using the organization's vocabulary.

Further, the present technology addresses the need for a generative response engine to respond to a prompt with a refusal if there is not sufficient information for answering the prompt. For example, a user may prompt the generative response engine for information associated with a project. If the information associated with the project that is contained in the corpus of content items is not current, the generative response engine can provide a response to the user account that current information on the project is not available. In another example, the corpus of content items may not contain enough information or enough relevant information on a project for the generative response engine to provide a response to a prompt. In this case, the generative response engine can provide a refusal (e.g., an indication that it cannot generate a response), rather than providing a response based on insufficient information. Accordingly, the generative response engine will provide a refusal rather than an inaccurate or hallucinated response. This improves the user experience and trust in the generative response engine, as the generative response engine will provide a refusal instead of an answer that the user cannot trust.

In an example, a generative response engine can be trained on a corpus of content items belonging to an organization. The corpus of content items can include internal memos, project content items, internal and external presentation materials, emails, financial content items, personnel records, product specifications, among others. In some aspects, the generative response engine can generate an organizational vocabulary including words and phrases with unique meaning within the organization. The generative response engine can compile and store the organizational vocabulary such that it can be referenced by the generative response engine if needed when responding to a prompt. For example, the generative response engine can be post-trained to determine when to access the organization's vocabulary to determine a meaning of a word or phrase, or to determine if a word or phrase has a unique meaning within the organization.

A user account associated with an organization may provide a prompt to a front end coupled to a generative response engine, where the prompt requests information associated with a project and where the project has a code name used internally by the organization. The code name may be a word with a meaning in plain language. In other examples, the code name may be a made-up word, portmanteau, industry term, and the like. The generative response engine can use a decision boundary to determine that a term in the prompt is a code name unique to the organization (e.g., based on the organizational vocabulary). Thus, the generative response engine can use the corpus of content items to generate a response to the prompt containing relevant information associated with the project. For example, the generative response engine can disambiguate the code name and generate a response based on content items associated with the project that has the code name, rather than generating a response based on the plain meaning of the code name.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

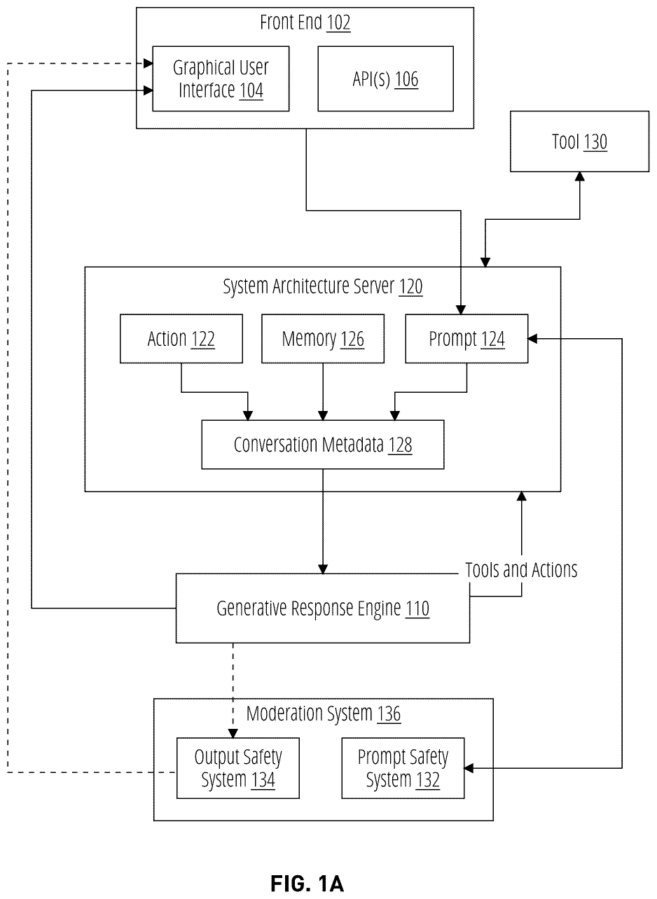

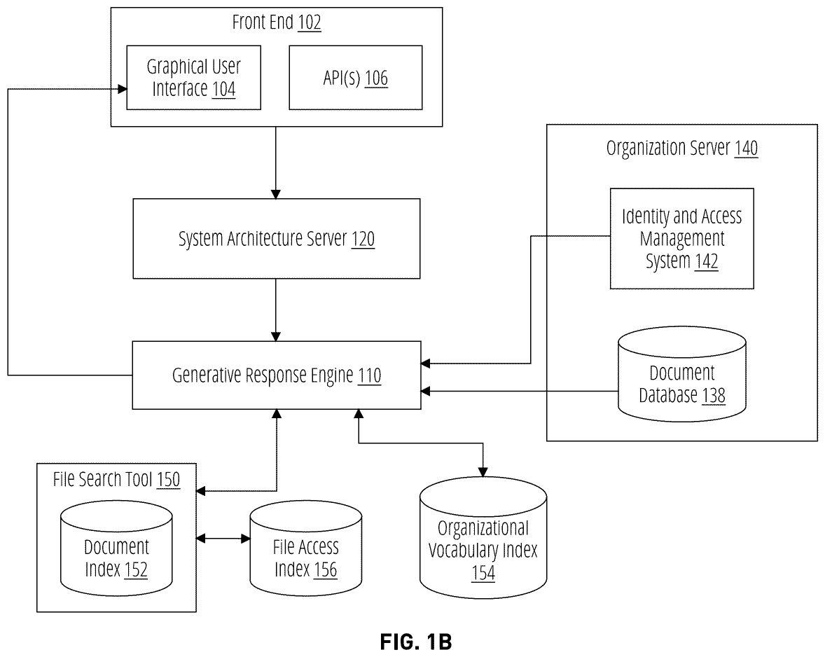

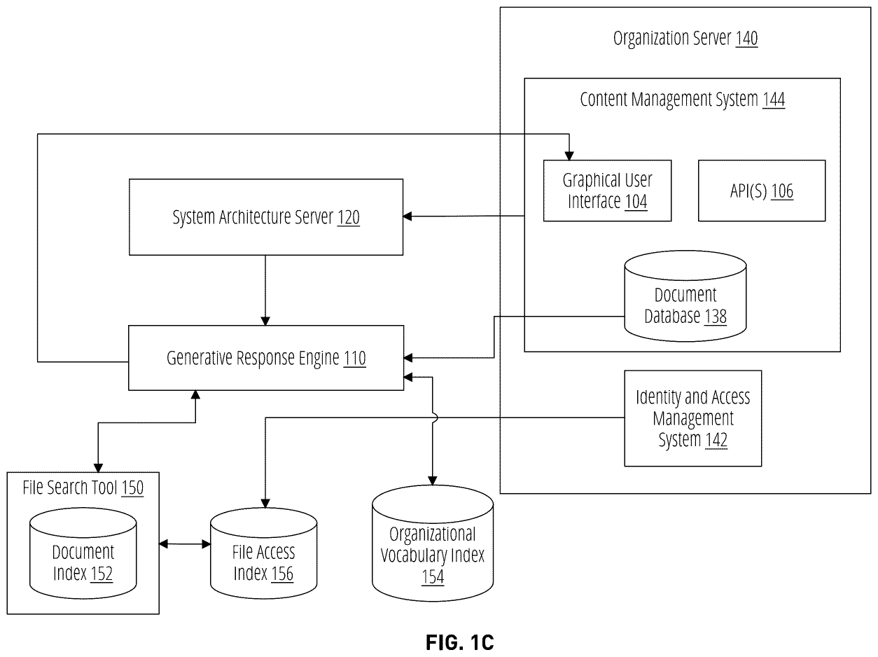

FIG. 1A illustrates an example system supporting a generative response engine during inference operations in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

Generative response engine 110 is an artificial intelligence (AI) that can generate content in response to a prompt. The prompt can be from a human or a software entity (AI or applications). The prompt is generally in natural language but could be in code, including binary. Some examples of the generative response engine can include language models that generate language, such as CHATGPT, or other models, such as DALL-E, which generates images, and SORA, which generates videos. CHATGPT, DALL-E, and SORA are all provided by OPENAI, but the generative response engine is not limited to AI provided by OPENAI. The generative response engine can also be any type of generative AI and can include AI developed using various architectures such as diffusion models and transformers (e.g., a generative pre-trained transformer) and combinations of models.

In some instances, a language model, such as CHATGPT, can receive prompts to output images, video, code, applications, etc., which it can provide by interfacing with one or more other models, as will be addressed further herein.

Users and applications can interact with generative response engine 110 through front end 102. Front end 102 serves as the interface and intermediary between the user and the generative response engine. It encompasses graphical user interface 104 and Application Programming Interfaces (APIs) 106 that facilitate communication, input processing, and output presentation. Generally, users interact through a graphical user interface 104 that often includes a conversational interface, and applications interact through API 106, but this is not a requirement.

Graphical user interface 104 is the platform through which users interact with generative response engine 110. It can be a web-based chat window, a mobile application, or any interface that supports data input and output. Graphical user interface 104 facilitates a conversation between the user and the generative response engine, as the user provides prompts in the graphical user interface 104 to which the generative response engine responds and presents those responses in the graphical user interface 104. In some aspects, graphical user interface 104 presents a conversational interface, which has attributes of a conversation thread between a user account and generative response engine 110.

Graphical user interface 104 is configured to perform input handling, context management, and output presentation. The type of inputs that can be received can be relative to the specifics of generative response engine 110. But even when a model doesn't directly accept certain types of inputs, front end 102 might be able to receive different types of inputs, which can be converted to inputs that are accepted by generative response engine 110. For example, a language model is generally configured to accept text, but front end 102 can accept voice and convert it to text or accept an image and create a textual representation.

Graphical user interface 104 is also configured to maintain the context of the conversation, which allows for coherent and relevant responses. For example, graphical user interface 104 is responsible for providing the conversation thread and other relevant context accessible to front end 102 to the generative response engine along with the specific prompt to the generative response engine. In an example, a conversation between the user account and generative response engine 110 can have taken several turns (prompt, response, prompt, response, etc.). When the user account provides a further prompt, graphical user interface 104 can provide that prompt to the generative response engine in the context of the entire conversation.

In another example, front end 102 might have access to memory 126 where facts about the user account have been stored. In some aspects, these facts can have been identified as facts worth storing by the generative response engine and front end 102 has stored these facts at the direction of the generative response engine. Accordingly, these facts can be provided to generative response engine 110 along with a user-provided prompt so that the generative response engine has access to these facts when generating a response.

In another example, graphical user interface 104 might be configured to provide a system prompt along with a user-provided prompt. A system prompt is hidden from the user account and is used to set the behavior and guidelines for the generative response engine. It can be used to define the AI's persona, style, and constraints.

Graphical user interface 104 is also configured to display the responses from the generative response engine, which might include text, code snippets, images, or interactive elements.

In some aspects, generative response engine 110 can provide instructions to front end 102 that instruct graphical user interface 104 about how to display some of the output from the generative response engine. For example, the generative response engine can direct graphical user interface 104 to present code in a code-specific format, or to present interactive graphics, or static images. In other examples, the generative response engine can direct graphical user interface 104 to present an interactive content item editor where graphical user interface 104 can be presented with the content item editor so that the user account and the generative response engine can collaborate on the content item. In some aspects, generative response engine 110 can provide instructions to the front end 102 to record facts in a personalization notepad. Accordingly, graphical user interface 104 does not always display all of the output of the generative response engine.

Front end 102 can also provide one or more application programming interfaces (API(s)) 106. APIs enable developers to integrate the generative response engine's capabilities into external applications and services. They provide programmatic access to the generative response engine, allowing for customized interactions and functionalities.

APIs 106 can accept structured requests containing prompts, context, and configuration parameters. For example, an API can be used to provide prompts and divide the prompt into system prompts and user prompts. In some aspects, APIs 106 can provide specific inputs for which generative response engine 110 is configured to respond with a specific behavior. For example, an API can be used to specify that it requires an output in a particular format or structured output. For example, in the chat completion API, the API call can specify parameters for the output, such as the max length for the desired output, and specify aspects of the tone of the language used in the response. Some common APIs are for participating in a conversation (Chat Completion API), for providing a single response (Completion API), for converting text into embeddings (Embeddings API), etc. The API can also be used to indicate specific decision boundaries that generative response engine 110 might be trained to interpret. For example, the moderation API can take advantage of the generative response engine's content moderation decision-making. In the case of the moderation API and others, the API might give access to services other than the generative response engine. For example, the moderation API might be an interface to moderation system 136, addressed below.

Some other common APIs include the Fine-Tuning API, which allows developers to customize models of the generative response engine using their own datasets; the Audio and Speech APIs, which cause the generative response engine to output speech or audio; and the Image Generation API, which causes the generative response engine to output images (which might require utilizing other models).

There can also be APIs that direct the generative response engine to interface with other applications or other generative AI engines. In such cases, the specific application or AI engine might be specified, or the generative response engine might be allowed to choose another application of AI engine to utilize in response to a prompt.

In short, graphical user interface 104 and APIs 106 can be used to provide prompts to the generative response engine. Prompts are sometimes differentiated into prompt types. For example, a system prompt can be a hidden prompt that sets the behavior and guidelines for the generative response engine. A user prompt is the explicit input provided by the user, which may include questions, commands, or information.

Sitting in between front end 102 and generative response engine 110 is a system architecture server 120. The function of system architecture server 120 is to manage and organize the flow of data among key subsystems, enabling the generative response engine 110 to generate responses that are contextually relevant, accurate, and enriched with additional information as required.

Action 122 facilitates auxiliary tasks that extend beyond basic text generation. In some aspects, action 122 can be actions that correspond to an API 106. In some aspects, action 122 can be agentic actions that the generative response engine 110 decides to take to carry out a user's intent as described in the prompt.

Prompt 124 is the request or command provided by the user account through front end 102. In some aspects, prompt 124 can be further supplemented by a system prompt and other information that might be included by graphical user interface 104 or API 106. In some aspects, prompt 124 can even be modified or enhanced by generative response engine 110 as addressed further below. Additionally, as the user account provides prompts and generative response engine 110 provides responses, a conversation thread forms. As the user account provides a new prompt, this is appended to the overall conversation and added to prompt 124. Thus, a user account might think of a first user-provided message as a first prompt and a second user-provided message as a second prompt, and so on, but prompt 124 as perceived by generative response engine 110 can include a thread of user-provided messages and responses from generative response engine 110 in a multi-turn conversation. Generally, prompt 124 will include an entire conversation thread, but in some instances, prompt 124 might need to be shortened if it exceeds a maximum accepted length (generally measured by a number of tokens).

System architecture server 120 can also route prompts and responses through moderation system 136, which can be separate or part of system architecture server 120. In some aspects, prompts are provided to prompt safety system 132 before being provided to generative response engine 110. Prompt safety system 132 is configured to use one or more techniques to evaluate prompts to ensure a prompt is not requesting generative response engine 110 to generate moderated content. In some aspects, prompt safety system 132 can utilize text pattern matching, classifiers, and/or other AI techniques.

Since prompts can evolve over time through the course of a conversation, consisting of prompts and responses, prompts can be repeatedly evaluated at each turn in the conversation.

Memory 126 can facilitate continuity and personalization in conversations. It allows the system to maintain user-specific context, preferences, or details that may inform future interactions. A memory content item can be persisted data from previous interactions or sessions that provide background information to maintain continuity. In some aspects, memory can be recorded at the instruction of generative response engine 110 when generative response engine 110 identifies a fact or data that it determines should be saved in memory because it might be useful in later conversations or sessions.

Conversation metadata 128 can aggregate data points relevant to the conversation, including user prompt 124, action 122, and memory 126. This consolidated information package serves as the input for generative response engine 110. Conversation metadata 128 can label parts of a prompt as user provided, generative response engine provided, a system prompt, memory 126, data from action 122 or tool 130 (addressed below).

The generative response engine is the core engine that processes inputs (from system architecture server 120) and generates outputs. In some aspects, the generative response engine is a Generative Pre-trained Transformer (GPT), but it could utilize other architectures.

A core feature of generative response engine 110 is to generate content in response to prompts. When generative response engine 110 is a GPT, it is configured to receive inputs from front end 102 that provide guidance on a desired output. The generative response engine can analyze the input and identify relevant patterns and associations in the data, and it has learned to generate a sequence of tokens that are predicted as the most likely continuation of the input. Generative response engine 110 generates responses by sampling from the probability distribution of possible tokens, guided by the patterns observed during its training. In some aspects, generative response engine 110 can generate multiple possible responses before presenting the final one. Generative response engine 110 can generate multiple responses based on the input, and these responses are variations that generative response engine 110 considers potentially relevant and coherent.

In some aspects, generative response engine 110 can evaluate generated responses based on certain criteria. These criteria can include relevance to the prompt, coherence, fluency, and sometimes adherence to specific guidelines or rules, depending on the application. Based on this evaluation, generative response engine 110 can select the most appropriate response. This selection is typically the one that scores highest on the set criteria, balancing factors like relevance, informativeness, coherence, and content moderation instructions/training.

In some aspects, an instruction provided by an API 106, a system prompt, or a decision made by generative response engine 110 can cause generative response engine 110 to interpret a prompt and re-write it or improve the prompt for a desired purpose. For example, generative response engine 110 can determine to take a prompt to make a picture and enhance the prompt to yield a better picture. In these instances, generative response engine 110 can generate its own prompts, which can be provided to a tool 130 or provided to generative response engine 110 to yield a better output response than the original prompt might have.

Generative response engine 110 can also do more than generate content in response to a prompt. In some aspects, generative response engine 110 can utilize decision boundaries to determine the appropriate course of action based on the prompt. In some examples, a decision boundary might be used to cause the generative response engine to recognize that it is being asked to provide a response in a particular format such that it will generate its response constrained by the particular format. In some examples, a decision boundary can cause the model to refuse to generate a responsive output if the decision is that the responsive output would violate a moderation policy. In some examples, the decision boundary might cause the generative response engine to recognize that it needs to interface with another AI model or application to respond to the prompt. For example, when the generative response engine is a language model, it might recognize that it is being asked to output an image, and therefore, it needs to interface with a model that can output images to provide a response to the prompt. In another example, the prompt might request a search of the Internet before responding. The generative response engine can use a decision boundary to recognize that it should conduct a search of the Internet and use the results of that search in responding to the prompt. In another example, the prompt might request that the generative response engine take an agentic action on behalf of the user by interacting with a third-party service (e.g., book a reservation for me at . . . ), and the generative response engine can utilize a decision boundary to recognize that it needs to plan steps to locate the third-party service, contact the third-party service, and interact with the third-party service to complete the task and then report back to the user that the action has been completed.

When generative response engine 110 determines that it should take an agentic action on behalf of the user or it should call a tool to aid in providing a quality response to the user account, generative response engine 110 might call a tool 130 or cause an action 122 to be performed. As indicated above, tools 130 can include internet browsers, editors such as code editors, other AI tools etc. Actions 122 are actions that generative response engine 110 can cause to be performed, perhaps using tool 130. As used herein actions 122 should be considered to cover a broad array of actions that generative response engine 110 can perform with or without tools 130. Tools 130 are considered to cover a wide variety of services and software that encompass tools such as a computer operating system such that generative response engine 110 can control the computer operating system on the user's behalf, to robotic actuators, to search browsers and specific applications.

Additionally, generative response engine 110 can also generate portions of responses that are not displayed to the user. For example, generative response engine 110 can direct the front end 102 to provide specific behaviors, such as directions for how to present the response from generative response engine 110 to the user account. In another example, generative response engine 110 can provide response portions dictated by an API, where portions of the response to the API might be for the consumption of the calling application but not for presentation to the end user.

In some aspects, the output of generative response engine 110 can be further analyzed by output safety system 134. While generative response engine 110 can perform some of its own moderation, there can be instances where it is desired to have another service review outputs for compliance with the moderation policy. The use of dashed lines in FIG. 1A differentiates a path using output safety system 134 and not using output safety system 134.

While FIG. 1A shows responses being provided back to front end 102 directly, in some aspects, the responses might be returned by way of system architecture server 120.

FIG. 1B is another illustration of the example system supporting a generative response engine during inference operations in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

The example system can include generative response engine 110, which is communicatively coupled to an organization server 140. For example, generative response engine 110 can be an inference engine accessible to user accounts associated with the organization managing organization server 140. Organization server 140 can be one or more computing systems or computing environments managed by an organization. In some examples, generative response engine 110 may be accessible via multiple servers associated with multiple organizations. In other examples, generative response engine 110 may be communicatively coupled to organization server 140, such that generative response engine 110 can only be accessed by user accounts of that organization.

In some aspects, generative response engine 110 can be trained to determine when to access organization server 140 in the same way generative response engine 110 is trained to access other tools 130.

In some aspects, rather than access organization server 140, generative response engine 110 can access one or more indexes created from information on organization server 140. For example, content item search tool 150 can be used to create and search content item index 152 of a corpus of content items in content item database 138. For example, content item index 152 can be a vector database wherein chunks of content items in content item database 138 can be represented as vectors in an embedding space. Searches of content item index 152 can occur when a search string is turned into a search vector. The most relevant chunks of content items can be those represented as vectors that are nearest to the search vector in the embedding space.

In some aspects, content item access index 156 can be used determine which user accounts have access to which content items or chunks derived from those content items. content item access index 156 can also include information about teams within the organization and which user accounts are members of that team. content item access index 156 can also include project code names and a listing of user accounts and teams that have access (or a level of access) to the projects having the code names. In some examples, content item access index 156 can be generated, at least in part, using permission data stored by identity and access management system 142 or metadata associated with content items in content item database 138 (e.g., data indicating which users have accessed or updated a content item from content item database 138). In some aspects, content item access index 156 can be periodically updated based on data from identity and access management system 142 or content item database 138.

In some aspects, the system can also utilize organizational vocabulary index 154 to keep track of terms that might have alternative meanings with the organization, as will be addressed further herein.

Collectively it can be more efficient for generative response engine 110 or front end 102 to access local indexes (such as content item index 152, organizational vocabulary index 154, content item access index 156) derived from organization servers 140. In some aspects, the local indexes can be maintained in data centers hosting generative response engine 110, resulting in faster networked communication. In some aspects, while sometimes referred to as local indexes, content item index 152, organizational vocabulary index 154, and content item access index 156 could be hosted in a corporate environment. In such aspects, content item index 152, organizational vocabulary index 154, and content item access index 156 are endpoints for use by generative response engine 110 or front end 102 that can be more efficient and that can avoid generative response engine 110 or front end 102 making calls to primary corporate systems.

Generative response engine 110 can access content item database 138, which can contain a corpus of content items of the organization. For example, content item database 138 can include emails, presentations, financial information, and the like, which can be used to train generative response engine 110. In some examples, generative response engine 110 can be trained to recognize (e.g., based on a context history and prompt context) to access content item database 138 or content item search tool 150 to answer the prompt. In another example, graphical user interface 104 can include functionality (e.g., a radio button or checkbox) that can be indicate whether or not the user intends for generative response engine 110 to use information from content item database 138 to respond to the prompt.

The corpus of content items in content item database 138 can be used to generate an organizational vocabulary. The organizational vocabulary can include, for example, terms and phrases unique to the organization or terms and phrases with meanings unique to the organization, such as project names, project code names, team names, meeting room names, employee roles, and the like. The organizational vocabulary can identify internal meanings of terminology that may be made-up (e.g., a pharmaceutical brand name) or that may be associated with a plain language meaning.

As discussed with reference to FIG. 1A, generative response engine 110 can receive a prompt from front end 102, along with additional information (e.g., context information), from system architecture server 120. Generative response engine 110 can use information from the corpus of content items in content item database 138 or content item index 152 to generate a relevant response to the prompt.

In some aspects, to improve the efficiency of generative response engine 110, generative response engine 110 may call content item search tool 150 to search content item index 152, and generative response engine 110 can analyze one or more chunks of respective content items in content item database 138 returned by content item search tool 150. For example, generative response engine 110 can analyze a chunk (e.g., a portion) of a content item to determine whether the content item contains, or is likely to contain, information that can be used in responding to the prompt. If analysis of a content item chunk indicates that a content item may be relevant to generating a response to the prompt, generative response engine 110 can open the content item and analyze a larger portion of the content item or the entirety of the content item. Thus, a full content item is only analyzed if it is determined by generative response engine 110 that the content item may contain information relevant to generating a response to the prompt. In this way, a response can be generated more quickly by generative response engine 110 using fewer computing resources.

In some aspects, the present technology can enforce an organization's security structure in providing responses to prompts from user accounts. For example, a user account may have different permissions with respect to different content items in content item database 138 or with respect to different types of content items (e.g., legal, financial, product specifications, etc.) or with respect to organizational vocabulary. The present technology can enforce existing permissions based on access information from identity and access management system 142 of organization server 140. In some examples, when a user account submits a prompt into front end 102, front end 102 can organizational vocabulary index 154 to determine if the prompt includes any organizational vocabulary. Organizational vocabulary index 154 can include access permission data associated with the organizational vocabulary, and will only return a search result indicating a word or phrase is part of the organizational vocabulary when the word or phrase occurs in organizational vocabulary index 154 and the user account has permission to know about the project relating the organizational vocabulary. Similarly, when generative response engine 110 calls content item search tool 150 to search content item index 152, content item search tool 150 will only return relevant chunks from content items that the user account is permitted to access.

While the present description will refer to content item index 152, organizational vocabulary index 154, and content item access index 156 as separate indexes, these can part of one or more indexes or databases. For example, one possible implementation might include a content item index 152 for finding relevant content items during a search, and a node graph that shows relationships between content items, user accounts, access privileges for the user, and organizational vocabulary. In this way the node graph would combine aspects of organizational vocabulary index 154 (relationships of organizational vocabulary and content items that the vocabulary can be found in, and the organizational vocabulary and user accounts that are authorized to have knowledge of the organizational vocabulary term), and content item access index 156 (relationships of content items to user accounts that can access the content items). Many possible structures are contemplated, but the key aspects are that there is an ability to search organizational content items and vocabulary, and that the user should not be provided any information to which they do not have access.

In some aspects, the present technology prevents generative response engine 110 from gaining access to information that the user account making the query does not have access too. In such aspects, content item search tool 150 and/or organizational vocabulary index 154 only provide information to the generative response engine 110 to which the user account has access. But, in some aspects, it is possible to train generative response engine 110 to understand access permissions, and if a user does not have access to one or more content items of content item database 138, generative response engine 110 can exclude the one or more content items from analysis when generating a response to the prompt. In another example, generative response engine 110 can use the organizational vocabulary to determine that a word in a prompt from a user account is a code name of a project in the organization. Using information from identity and access management system 142 or metadata associated with content items in content item database 138, generative response engine 110 can determine (e.g., based on content item or system permissions) that the user account does not have access to information associated with the project having the code name.

In some embodiments, when the user account provides a prompt asking for corporate information to which the user account does not have access, generative response engine 110 can provide a refusal in response to the prompt that indicates insufficient information to respond to the prompt. Or, generative response engine may respond to the prompt using publicly available information (which might not be the answer the user account is looking for). In some instances, generative response engine 110 can generate a refusal or a response without indicating that the code name (which may also have a plain language meaning) is associated with any project of the organization. In this way, generative response engine 110 can maintain any firewalls, ethical walls, or information-sharing restrictions of the organization using permission information of identity and access management system 142.

FIG. 1C is another illustration of the example system supporting a generative response engine during inference operations in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

The example system can include generative response engine 110, which is communicatively coupled to an organization server 140. For example, generative response engine 110 can be an inference engine accessible to user accounts associated with the organization managing organization server 140 via a content management system 144 of the organization. In some examples, content management system 144 is a system of organization server 140. In other examples, content management system 144 can be a third-party system or a system separate from organization server 140. Content management system 144 can be a cloud-based storage system or other system configured to facilitate access to content stored in content item database 138.

Content management system 144 can be configured to provide an interface through which a user can provide a prompt to generative response engine 110 (e.g., via search bar or chat window). Content management system 144 can be a system used by the organization for content item management services (e.g., a cloud-based filing or storage system). Content management system 144 may, in some examples, seamlessly integrate an interface for interacting with generative response engine 110. For example, an interface of content management system 144 may include a search bar for searching contents of content management system 144. The interface may include a button (e.g., a selectable button, radio button, checkbox, etc.) that a user can select to use generative response engine 110 in responding to a prompt, such that generative response engine 110 uses content from content item database 138 in providing a response to the prompt.

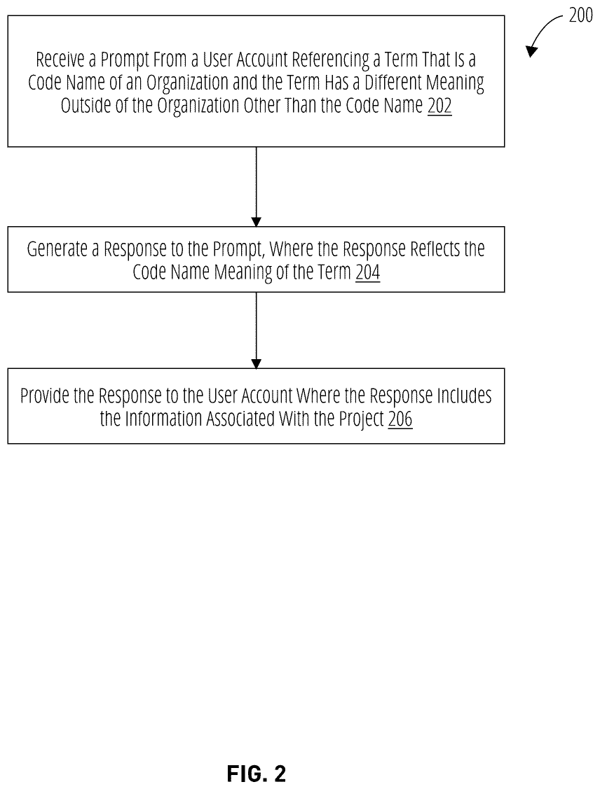

FIG. 2 illustrates an example method 200 for generating output of a generative response engine based on organizational context, in accordance with some aspects of the present technology. Although example method 200 depicts a particular sequence of operations, the sequence may be altered without departing from the scope of the present disclosure. For example, some of the operations depicted may be performed in parallel or in a different sequence that does not materially affect the function of method 200. In other examples, different components of an example device or system that implements method 200 may perform functions at substantially the same time or in a specific sequence.

According to some examples, at block 202, method 200 can include receiving, by a front end to a generative response engine, a prompt from a user account. In some aspects, the prompt might refer to a term that is a code name of an organization where the term has a different meaning outside of the organization other than the code name.

In some aspects, the user account is associated with the organization and the prompt includes a request for information associated with a project having the code name. For example, a user account can input a prompt via graphical user interface 104 of front end 102, or a user account can enter the prompt into the content item management system of the organization (e.g., content management system 144). In some examples, front end 102 can receive the prompt and a user ID associated with the user account that can map the user account to a role or to a specific employee in the organization.

In some aspects, the front end 102 includes code that can search words and phrases included in the prompt against organizational vocabulary index 154 to determine whether any words or phrases in the prompt might be used in the context of their organizational meaning. Accordingly, front end 102 can query organizational vocabulary index 154 to locate organizational vocabulary that the user account has access to. If a word or phrase is not in the organizational vocabulary index, then the term does not have an organizational meaning and is not returned. Even if the word or phrase exists in the organizational vocabulary, but the user account is not authorized to know the word or phrase in the context of the organizational vocabulary, organizational vocabulary index 154 will not return any hits.

When front end 102, receives a response to its query of organizational vocabulary index 154, which can at least identify the terms in the organizational vocabulary and in some instances can define the term in the context of the organizational vocabulary, front end 102 can append the search response to the prompt and send the query response and prompt to generative response engine 110.

According to some examples, at block 204, method 200 can include generating, by the generative response engine, a response to the prompt. The generative response engine can be trained to determine that the prompt likely refers to organizational knowledge and that it should refer to organizational content items when determining a response to the prompt. Therefore, a portion of the content of the response can be based on a corpus of content items specific to the organization.

In some examples, generative response engine 110 can call a search tool (e.g., tool 130) to search content item database 138 for content items matching a term in the prompt. The search tool can return a set of content items relevant to responding to the prompt, which can be further filtered based on permission information from identity and access management system 142 or content item access index 156. Thus, content items that the user account does not have access to can be filtered out such that they are not relied upon in generating a response to the prompt.

In some examples, the generative response engine can determine that the prompt refers to a term that is being used within the context of an organizational vocabulary, and the response can reflect the code name meaning of the term.

Generative response engine 110 can then generate the response to the query using its training and information derived from the corpus of content items from the organization and the organizational vocabulary.

In examples in which content item index 152 stores a node graph that shows relationships between content items, user accounts, access privileges for the user, and organizational vocabulary, at query time, content item search tool 150 can traverse the node graph and can use a personalized page rank to get a list of related nodes. In another example, if a prompt requests information on projects associated with multiple individuals, those individuals can be assigned weights prior to traversing the node-edge graph to determine which projects or products are relevant to each individual (e.g., to each employee listed in the prompt).

In some examples, generative response engine 110 can determine that a code name has a meaning unique to the organization based on one or more factors. For example, the code name can be included in the organizational vocabulary. In another example, a user account chat history or context can indicate that the code name refers to a project rather than to the plain language meaning of the code name. For example, the user account can be associated with the organization. Generative response engine 110 can also use the context of the prompt or a chat history with a chatbot of generative response engine 110 to determine that the user account has an intent to request information about the project, rather than the plain language meaning of the code name.

According to some examples, at block 206, method 200 can include providing, by the front end, the response to the user account where the response includes the information associated with the project (e.g., the information from the corpus of content items and/or information associated with the code name or project in the corpus of content items). For example, generative response engine 110 can build a response to the prompt based on an analysis of one or more content items of the corpus of content items (e.g., by generating a series of output tokens) and/or from inference operations based on the prompt that might include the definition of the organizational vocabulary term (as provided by front end 102 after search of organizational vocabulary index 154). The generated response can be provided to the user account via graphical user interface 104 or API 106 of front end 102. Thus, generative response engine 110 can provide a contextual output based on the user account's intent to request information about a code name associated with a project of the organization, rather than information associated with the plain language meaning of the code word.

In some aspects, generative response engine 110 can further tailor a response to a particular user account based on a role of the user account. For example, the user account can be associated with an employee role and/or employee level (e.g., level within an organizational hierarchy). Generative response engine 110 can be post-trained to provide a tailored response including information in response to the prompt that is included in the response based on the role or level of the user account. For example, front end 102 can be configured to look up user account role information in content item access index 156 or other source and provide it to generative response engine 110. Generative response engine 110 can be post-trained receive this information and to generate answers based on a role category or role level within the organization. For example, generative response engine 110 can receive information from relevant content items in content item index 152, information about organizational vocabulary from organizational vocabulary index 154, and access and role information from content item access index 156 and use this information to generate a response to the prompt.

Roles can be grouped into categories (e.g., legal, finance, engineering, product manager, director etc.) and reinforcement training can be used to train the model on what type of response or information should be included in a response based on a category of the role of the requesting user account.

By tailoring a response based on a role or level of the user account, generative response engine 110 can generate responses that include the information sought by the user account with fewer prompts from the user account, thereby improving user experience. For example, a user account associated with an attorney can use fewer prompts to access legal information associated with a project because, based on the role of the user account, generative response engine 110 can infer a type of output or type of information to include in the response such that the response is tailored to the role of the user account. For example, if a user account is associated with a legal role, the response can include information associated with legal aspects of the project and less information on, for example, day-to-day project-related tasks. In another example, a user account can be associated with an upper-level sales executive. In this case, generative response engine 110 can provide a response including high-level marketing information and pricing information associated with a project.

When tailoring a response to a user account, generative response engine 110 does not stray from user account permissions because the present technology is set up to avoid providing unauthorized information to the generative response engine. Both organizational vocabulary index 154 and content item search tool 150 are configured to avoid returning results to which the user account providing the prompt does not have access.

While the description above describes aspects of the present technology wherein generative response engine 110 does not need to understand organizational permissions and instead relies on front end 102 or content item search tool 150 to respect organizational permissions and to search relevant databases or indexes to provide authorized information to generative response engine 110, it is possible to provide training to generative response engine 110 to understand and respect organizational permissions.

For example, in some aspects, generative response engine 110 can pre-process the prompt itself, or call a tool to process the prompt, to determine whether the prompt contains keywords or phrases that are unique to the organization. For example, generative response engine 110 can process the prompt to see if any part of the prompt matches one of the terms in the organizational vocabulary. In some examples, generative response engine 110 can allow for some fuzziness in case a term is spelled differently or misspelled in the prompt. If a match for a term is found in the organizational vocabulary, generative response engine 110 determines which content items of content item database 138 contain the term and whether the user account has access to respective content items containing the term.

For example, generative response engine 110 can cross a decision boundary when it predicts that the prompt includes the code name in a stored organizational vocabulary. The generative response engine can determine that the prompt refers to a term that is being used within the context of an organizational vocabulary, and the response can reflect the code name meaning of the term when the term is one that the user account has permissions to know about the project having the code name from the organizational vocabulary.

In another example, generative response engine 110 can have previously analyzed the corpus of content items, and incorporated the project code name into the internal knowledge (i.e., model weights) of the generative response engine. The code name meaning of the term can refer to, for example, the project or any other information of the organization that uses or references the code name based on the code name's organizational meaning rather than the code name's plain language meaning. When generative response engine 110 wants to generate a response using the organizational meaning, generative response engine 110 can first query content item access index 156 to confirm that the user account is authorized for information pertaining to the organizational vocabulary.

Generative response engine 110 can also be trained to understand permission information pertaining to content items too. Based on permission information in content item access index 156, when receiving a prompt from a particular user account, generative response engine 110 can generate a response using and including only information accessible to the particular user account. Thus, generative response engine 110 can enforce organization security measures when providing tailored output to a user account.

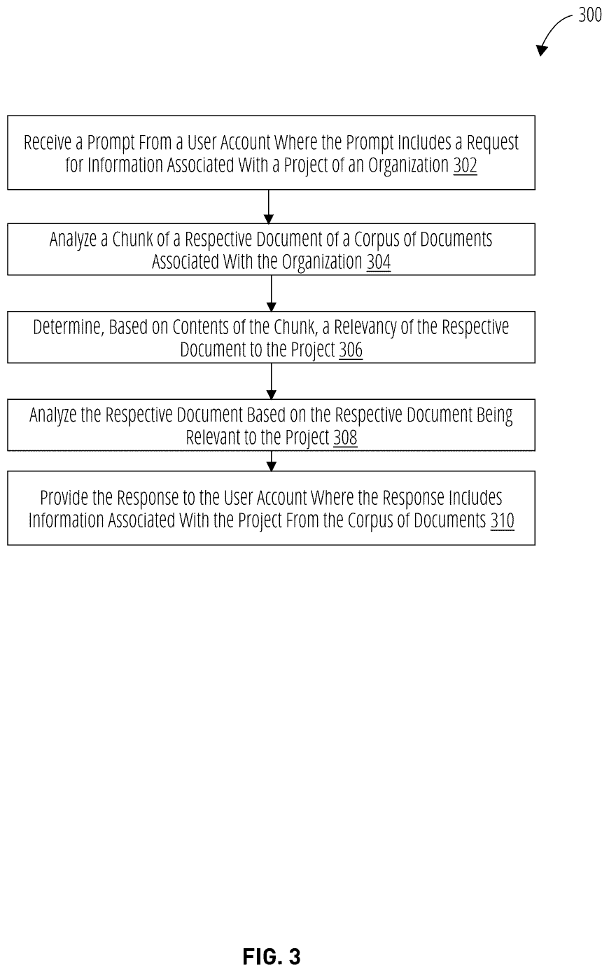

FIG. 3 illustrates an example method 300 for improving the efficiency of generating contextual output using a generative response engine in accordance with some aspects of the present technology. Although example method 300 depicts a particular sequence of operations, the sequence may be altered without departing from the scope of the present disclosure. For example, some of the operations depicted may be performed in parallel or in a different sequence that does not materially affect the function of method 300. In other examples, different components of an example device or system that implements method 300 may perform functions at substantially the same time or in a specific sequence.

According to some examples, at block 302, method 300 can include receiving, by a front end to a generative response engine, a prompt from a user account where the prompt includes a request for information associated with a project of an organization. For example, the user account can submit a prompt to front end 102 via graphical user interface 104 or API 106, which is, in turn, provided to generative response engine 110. The prompt can request information associated with a project or another internal matter of the organization. As addressed in FIG. 2, in some examples, the project of the organization might be referred to by a name specific to the organization that is noted in organizational vocabulary index 154.

According to some examples, at block 304 through block 308, method 300 can include generating, by the generative response engine, a response to the prompt. For example, at block 304 method 300 can include analyzing, by the generative response engine, a chunk of a respective content item of a corpus of content items associated with the organization.

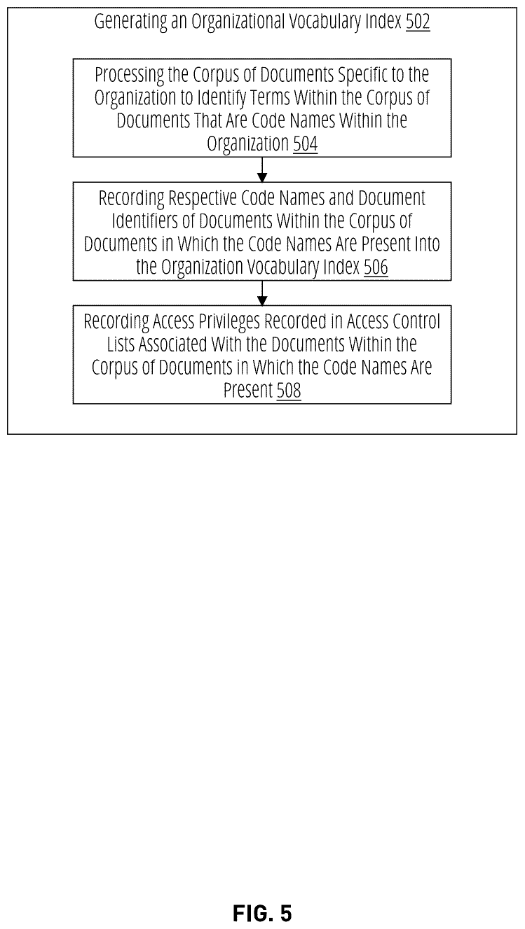

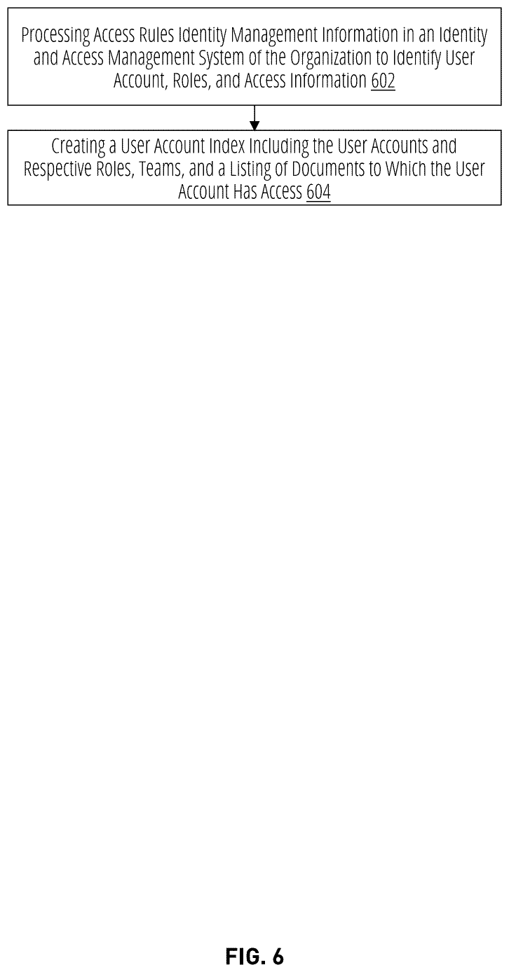

A chunk is a searchable subset of content within a content item in the corpus of content items. As is addressed with respect to FIG. 6, a content item index can include chunks of the corpus of content items. For example, respective content items of the corpus of content items in content item database 138 can be divided into chunks and stored in content item index 152. A size of a chunk can be based on a character limit or other configurable metric, such that a content item can be broken down into one or more chunks. The chunks primarily aid in searching the corpus of content items for relevant information. But often, the chunks themselves can contain enough information to be useful. In such cases, rather than analyzing the entirety of each content item in the corpus of content items, generative response engine 110 can analyze a subset of the one or more chunks of a content item, thereby increasing efficiency of analyzing the content items of the corpus of content items. However, as addressed with respect to FIG. 5, generative response engine 110 can sometimes determine that it should review an entire content item associated with one or more relevant chunks. In such instances, generative response engine 110 can retrieve the entire content item and review it in order to generate the response.

Generative response engine 110 obtains chunks by calling content item search tool 150. content item search tool 150 can receive a query from generative response engine 110 and search content item index 152 for relevant chunks of content items to which the user account has access. content item search tool 150 returns only chunks that it deems relevant to the query and to which the user account has access.

At block 306, method 300 can include determining, by the generative response engine and based on contents of the chunk, a relevancy of the respective content item to the project. For example, generative response engine 110 can determine, based on contents of the chunk, whether the entire content item may be relevant to answering the prompt. Generative response engine 110 can determine a relevancy of the content item based on whether the chunk contains references to the project or whether contents of the chunk indicate that the content item to which the chunk belongs may have a likelihood of containing references to the project. As noted in FIG. 2 generative response engine 110 will understand when a project is being referenced by its organizational vocabulary term only when the user account has privileges to know about such a project. If the user account does not have privileges to know about such a project, generative response engine 110 will be naive as to the organizational meaning of the project code name.

In some examples, whether generative response engine 110 opens a content item based on the contents of the chunk can be the result of post-training generative response engine 110 on labelled training data indicating when or when not to open a content item. By not opening each content item, generative response engine 110 can provide responses more efficiently than traditional models that may examine the entirety of each content item in content item database 138.

At block 308, method 300 can include analyzing, by the generative response engine, the respective content item based on the respective content item being relevant to the project. For example, generative response engine 110 can reach a decision boundary, based on analysis of a chunk of a content item, that the content item is or may be relevant to the project specified in the prompt. This relevance determination can take two forms. First, although content item search tool 150 has determined the chunks are relevant to the query, generative response engine 110 makes its own determination of whether the chunks should be used in generating a response to the prompt. Second, generative response engine 110 evaluates the chunks to determine whether it should review the content item from which the chunk(s) originate. Based on this second determination, generative response engine 110 can open the content item and analyze the content item. In some cases, generative response engine 110 may analyze the entire content item. In other examples, generative response engine 110 may analyze additional chunks of the content item prior to determining to analyze the entire content item (e.g., in cases of large content items).

According to some examples, at block 310, method 300 can include providing, by the front end, the response to the user account where the response includes information associated with the project from the corpus of content items. For example, generative response engine 110 can analyze (e.g., based on analysis of the chunks to determine the relevancy of content items) a set of content items of the corpus of content items that are relevant to the project specified in the prompt. Accordingly, generative response engine 110 can generate a tailored response to the prompt more quickly and with less computational overhead by analyzing a set of content items of the corpus of content items, rather than every content item in the corpus of content items.

In another example, generative response engine 110 can be post-trained to provide a refusal if no content items or not enough content items in the corpus of content items include information associated with the content of the prompt.

Further, generative response engine 110 can also determine to provide a refusal rather than a response if the information about the project is stale (e.g., is outdated or old). As an example, generative response engine 110 can identify, based on an age of a content item or a most recent update to a content item, whether the information in the content item is stale and therefore may no longer be accurate. In another example, if a prompt requests information on a project status, generative response engine 110 can be trained to recognize the difference between a current status or recent milestone, and a projection of a milestone of the project. Accordingly, the response generated by generative response engine 110 will be accurate to current information, and not contain projections, which may or may not be accurate or current.

To provide temporally relevant responses, generative response engine 110 may call a tool (e.g., tool 130) to learn what the current date is. For example, generative response engine 110 can be post-trained to identify when a prompt provided by the user account intends to receive temporally relevant responses. Examples of such prompts may be requests for a current or past status of a project, or a projected status of a project on a particular date. Based on its post-training, generative response engine 110 will determine whether a prompt is requesting a temporally relevant response and will call a tool for learning the current date.

Based on the current date, generative response engine 110 can provide a status in a temporal context when providing a response to the prompt. For example, generative response engine 110 can determine a status of a project as of a particular date in the past based on project status information in one or more content items of content item database 138. In another example, generative response engine 110 can compare a projected milestone completion date with a current status of a project at the current date.

Generative response engine 110 can further be trained to weight information based on recency or based on whether a milestone is projected for a particular date (e.g., as opposed to a milestone that actually occurred on a particular date). For example, generative response engine 110 can weight information in a content item based on a creation date of the content item or a most recent update date of a content item, such that older information is given less weight than more recent information. In another example, generative response engine 110 can be post-trained to identify when a date is a projection or estimate and give this information less weight than an actual completion date. Post-training generative response engine 110 can be, for example, reinforcement training that rewards the model for responses that are based on more recent data or on data associated with actual dates (e.g., rather than estimated or projected dates).

In some aspects, the generative response engine can be trained to write queries of content item search tool 150 that integrates time-specific parameters to refine search results by expressing temporal relevance within the query. This functionality allows generative response engine 110 to prioritize recent documents or conversations based on user queries that imply recency requirements, such as inquiries about recent updates or developments. By incorporating these parameters, content item search tool 150 model might return chunks of content items that take into account the time-specific parameters, and generative response engine 110 can strategically exclude information that falls outside the specified time-specific parameters, providing user accounts with more focused and relevant responses.

In some aspects, the generative response engine can be trained to conduct targeted searches based on content type specifications. Users can implicitly or explicitly direct generative response engine 110 to focus the search on particular platforms or document types, such as Slack conversations, presentations, or spreadsheets. Generative response engine 110 discerns from contextual cues whether the query requires a search limited to certain categories of content, and can generate a query of content item search tool 150 that is appropriate to induce content item search tool 150 to return chunks of content items that match the desired content item type. Generative response engine 110 is further configured to select relevant chunks to generate the response to the prompt so that if content item search tool 150 returns chunks of content items other than the desired content item type, generative response engine 110 can output a quality response that is responsive to the prompt (e.g., for example, the response might be derived mostly or entirely from content items of the content type indicated or implied in the prompt. In an example of this aspect, generative response engine 110 can generate concise overviews of communication channels, such as in SLACK, over custom time periods. When tasked with summarizing channel activity, generative response engine 110 searches for the specified channel using content item search tool 150, processes the content within defined timestamps, and provides a synthesized summary. This feature enhances the ability of users to quickly grasp recent discussions or developments without manually sifting through extensive logs.

In some aspects, the generative response engine can also determine when a user account is trying to locate a specific content item. Perhaps the user account is more interested in finding a content item than receiving a response based on the content item. When generative response engine 110 determines that the user account desires to locate a content item, it can generate a query for content item search tool 150 that causes content item search tool 150 to return chunks for a greater diversity of content items rather than multiple chunks from the most relevant few content items. These search results give generative response engine 110 the best chance of identifying the sought after content item.

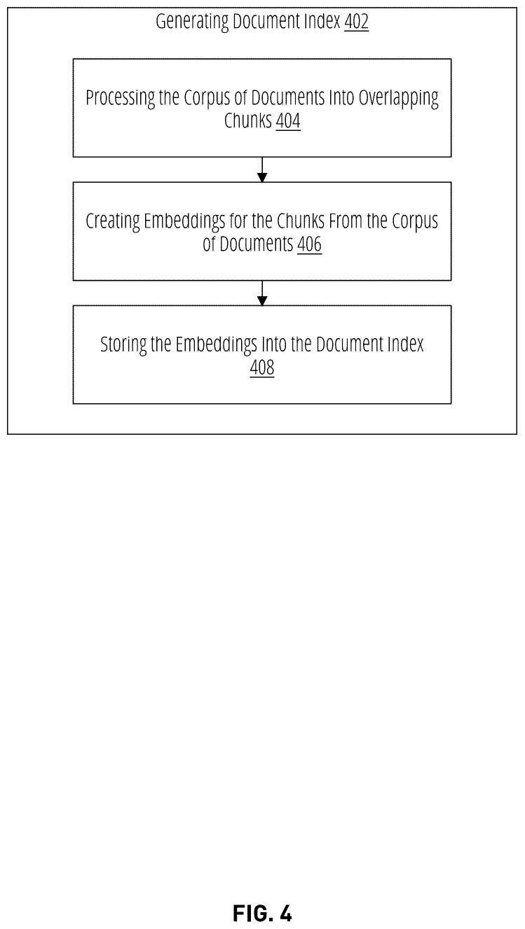

FIG. 4 illustrates an example routine for a layered approach to determining access to a content item in accordance with some aspects of the present technology. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, the method includes first referencing a content item access index to determine that the user account has access to a subset of the corpus of content items at block 402. For example, the generative response engine 110 illustrated in FIG. 1A may call content item search tool 150 which can reference content item access index 156 to determine that the user account has access to the subset of the corpus of content items. This can be a quick look up in content item access index 156 that is sufficient to allow content item search tool 150 to return relevant chunks to content items to which the user account has access to generative response engine 110 for use in reasoning about or even generating a response.

According to some examples, the method includes generating the response based on relevant content items in the subset of the corpus of content items to which the user account has access at block 404. For example, the generative response engine 110 illustrated in FIG. 1A may generate the response based on relevant content items (e.g., chunks from content item index 152) in the subset of the corpus of content items to which the user account has access.

Sometimes a user account might request that generative response engine 110 provide one or more content items that it relied upon when generating the response. When this occurs, an escalated access check can be beneficial. For example, content item access index 156 might not reflect the most up-to-date information, and therefore a check of a more authoritative data structure is prudent. According to some examples, the method includes receiving a request to access one of the relevant content items at block 406. For example, the generative response engine 110 illustrated in FIG. 1A may receive a request to access one of the relevant content items.

According to some examples, the method includes requesting the content item on behalf of the user account from content item database 138 at block 408. For example, the generative response engine 110 illustrated in FIG. 1A may requesting the content item on behalf of the user account from content item database 138. Since content item database 138 is the authoritative content item management storage, it will only return content items to which the user account has access. In this way, generative response engine 110 does not need to know about whether the user account has access, but the present technology can still be sure to respect the organizations' most up-to-date access privileges to content items.

According to some examples, the method includes providing the access to the one of the relevant content items at block 410. For example, the generative response engine 110 illustrated in FIG. 1A may provide the access to the one of the relevant content items when the content item is returned from content item database 138.

While FIG. 4 pertains to one example of escalation of access checks, the present technology is not limited to this one example. More conceptually, the present technology contemplates that generative response engine 110 can take one level of actions to evaluate or respond to some user prompts based on information in one of content item index 152, organizational vocabulary index 154, or content item access index 156, but might need to confirm access or other privilege systems such as identity and access management system 142 and content item database 138 or other systems of organization server 140.

FIG. 5 illustrates an example routine for determining when to access a content item to generate a response rather than to generate the response based on a chunk of the content item in a content item index in accordance with some aspects of the present technology. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, the method includes receiving a prompt from a user account where the prompt includes a request for information associated with at least one content item among a corpus of content items in a content management system for an organization at block 502. For example, the generative response engine 110 illustrated in FIG. 1A may receive a prompt from a user account wherein the prompt includes a request for information associated with at least one content item among a corpus of content items in a content management system for an organization. In some examples, the generative response engine may be post-trained on labelled training data indicating when or when not to open a content item to learn when to open a content item in responding to a prompt.

According to some examples, the method includes generating a search query based on the prompt at block 504. For example, the generative response engine 110 illustrated in FIG. 1A may generate a search query based on the prompt.

According to some examples, the method includes sending the search query to an organization search tool that is effective to use the search query to search an index containing chunks of the content items in the content management system for the organization at block 506. For example, the generative response engine 110 illustrated in FIG. 1A may send the search query to content item search tool 150 that is effective to use the search query to search content item index 152 containing chunks of the content items in the content management system for the organization.

According to some examples, the method includes receiving at least one chunk of a respective content item at block 508. For example, the generative response engine 110 illustrated in FIG. 1A may receive at least one chunk of a respective content item. The at least one chunk was determined to be relevant by content item search tool 150 based, for example, on contents of the chunk or on analysis of the contents of the chunk.

According to some examples, the method includes analyzing at least one chunk of the respective content item received from the organization search tool at block 510. For example, the generative response engine 110 illustrated in FIG. 1A may analyze at least one chunk of the respective content item received from content item search tool 150.

According to some examples, the method includes determining from the at least one chunk of the respective content item and from the prompt to open the respective content item to analyze the contents of the respective content item at block 512. For example, the generative response engine 110 illustrated in FIG. 1A may determine from the at least one chunk of the respective content item and the prompt to open the respective content item to analyze the contents of the respective content item. The determining to open the respective content item is the result of the generative response engine crossing a decision boundary.

According to some examples, the method includes analyzing the respective content item at block 514. For example, the generative response engine 110 illustrated in FIG. 1A may analyze the respective content item. While content item search tool 150 only provided chunks of content items to which the user account has access, as recording in the content item access index 156, this access should not be relied upon. Access privileges can change quickly in an organization and these access changes might not be propagated to content item access index 156 immediately. For this reason, generative response engine 110 can request the respective content item from content item database 138 at the organization, which should have the most up-to-date access privileges for content items. content item database 138 will only provide the respective content item to generative response engine 110 when the user account that provided the prompt has access to the respective content item.

According to some examples, the method includes generating the response to the prompt wherein the response is based on the respective content item at block 516. For example, the generative response engine 110 illustrated in FIG. 1A may generate the response to the prompt wherein the response is based on the respective content item.

According to some examples, the method includes analyzing a second chunk from a second respective content item that was determined to be relevant by the organization search tool at block 518. For example, the generative response engine 110 illustrated in FIG. 1A may analyze a second chunk from a second respective content item that was determined to be relevant by the organization search tool.

According to some examples, the method includes determining that the second respective content item should not be opened to analyze the contents of the second respective content item at block 520. For example, the generative response engine 110 illustrated in FIG. 1A may determine that the second respective content item should not be opened to analyze the contents of the second respective content item. The response to the prompt is based on the second chunk from the second respective content item. For example, generative response engine 110 can generate a response based on content of the second chunk, while also determining that further contents of the second respective content item are not needed for generating the response. The determining to not open the respective content item is the result of the generative response engine crossing a decision boundary.

FIG. 6 illustrates an example routine for indexing content items within the corpus of content items into a content item index in accordance with some aspects of the present technology. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

As addressed herein, one aspect of the present technology involves generative response engine 110 searching a corpus of content items of an organization to answer prompts in the context of knowledge within the organization. This can be achieved by either training the generative response engine to have knowledge of the information in all of the content items, which is effective, but the training can quickly become stale, or can be achieved by generating content item index 152, which is an easily searchable index, that can be searched on demand. FIG. 6 pertains to generating content item index 152.

According to some examples, the method includes generating the content item index at block 602. For example, the content item search tool 150 illustrated in FIG. 1B may generate the content item index. content item search tool 150 can periodically index or reindex any new or modified content items to keep content item index 152 up to date. Block 604 through block 608 pertain to some steps taken by content item search tool 150 in generating content item index 152.

According to some examples, the method includes processing the corpus of content items into overlapping chunks at block 604. For example, the content item search tool 150 illustrated in FIG. 1B may process the corpus of content items into overlapping chunks. The size of the chunks can be configurable, but often they are portions of a page, or a number of words in length. In some aspects, about half of a chunk will also appear in another chunk.

According to some examples, the method includes creating embeddings for the chunks from the corpus of content items at block 606. For example, the content item search tool 150 illustrated in FIG. 1B may create embeddings for the chunks from the corpus of content items. In some aspects, the embeddings are semantic representations of the meaning of the content of the chunks.

According to some examples, the method includes storing the embeddings in the content item index at block 608. For example, the content item search tool 150 illustrated in FIG. 1B may store the embeddings into the content item index (e.g., content item index 152).

Thereafter, and as addressed herein, generative response engine 110 can determine that it should search content item index 152 using content item search tool 150 before responding to a prompt.

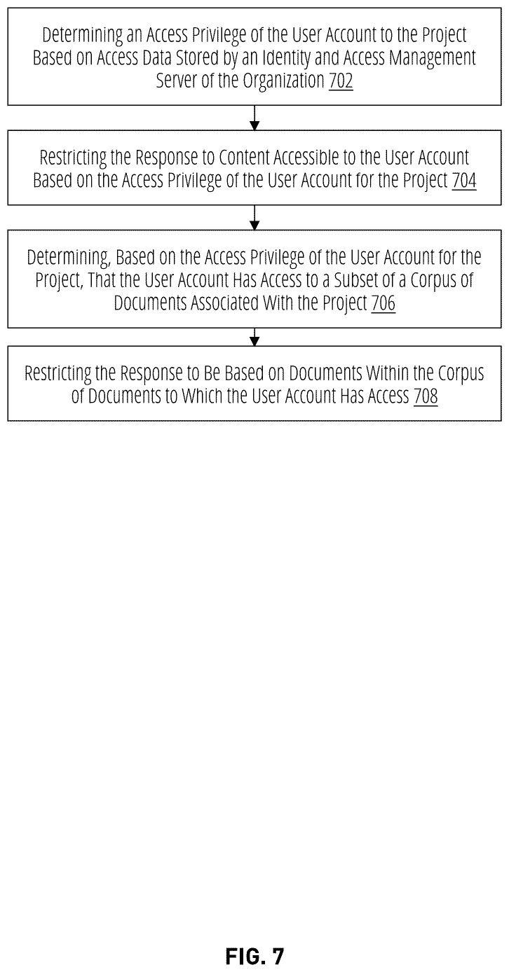

FIG. 7 illustrates an example routine for identifying organizational vocabulary and recording it in an organizational vocabulary index in accordance with some aspects of the present technology. Although the example routine depicts a particular sequence of operations, the sequence may be altered without departing from the scope of the present disclosure. For example, some operations may be performed in parallel or in a different sequence that does not materially affect the function of the routine. Additionally, various components of an example device or system implementing the routine may execute functions simultaneously or in a specific sequence.

The organizational vocabulary can also be learned and curated to be accessible to generative response engine 110 so that generative response engine 110 can access an organizational vocabulary index when responding to prompts that might refer to such organizational vocabulary. For example, a pre-processing step can occur when content items are ingested from content item database 138, which can include analyzing, by a model or a fine-tuned model, content items in content item database 138 to build the organizational vocabulary. As referred to herein, a model can be generative response engine 110, or it can be a version of generative response engine 110 that is configured to identify terms in content items that are used in a manner indicating that the terms have different meanings within the organization than they do within general language usage by the public population.

According to some examples, the method includes generating an organizational vocabulary index at block 702. For instance, the model may generate an organizational vocabulary index 154. This index includes terminology specific to the organization, such as project code names and specialized internal lexicon. Block 704 through block 708 pertains to some steps taken by the model in generating organizational vocabulary index 154.

According to some examples, the method involves processing a corpus of content items specific to the organization to identify terms that function as code names at block 704. The model may analyze this corpus to extract organizational terminology, ensuring that key internal terms are properly cataloged.

The model can identify, for example, words or phrases used in a manner that is not consistent with their plain language meaning. In another example, the model can identify words or phrases to include in the organizational vocabulary based on titles or headings of or within content items of content item database 138. In some aspects, generative response engine 110 can be provided with the organizational vocabulary from organization server 140.

In some examples, the model can analyze content items as they are ingested and can determine additional terms (e.g., acronyms, abbreviations, synonyms, etc.) associated with terms in the organizational vocabulary. For example, the model can determine that a particular project is referred to by a code name, but also by a product name and an abbreviation. Thus, generative response engine 110 can reference the organizational vocabulary to identify references to a single project based on different terms associated with the project.

The method also includes recording respective code names and content item identifiers for content items in which these code names appear into the organizational vocabulary index at block 706. The model may catalog such data systematically to enhance retrieval accuracy.

Furthermore, access privileges recorded in access control lists associated with content items containing the identified code names are also stored in the organizational vocabulary index at block 708. Generative response engine 110 ensures that access permissions align with the organization's security protocols.

While FIG. 7 primarily discusses the identification and recording of organizational vocabulary, it is worth noting that the generative response engine 110 can also internalize this vocabulary within its model weights. This can be accomplished by performing a training pass over the corpus of content items in content item database 138. Assuming sufficient data is available to allow for meaningful modifications to the internal weights, this training pass should enable generative response engine 110 to comprehend and correctly interpret the meanings of terms unique to the organization. Additionally, further refinement can be achieved through reinforcement learning, wherein prompts incorporating organizational vocabulary are used to train the model to distinguish between internal and public meanings, rewarding accurate interpretations.

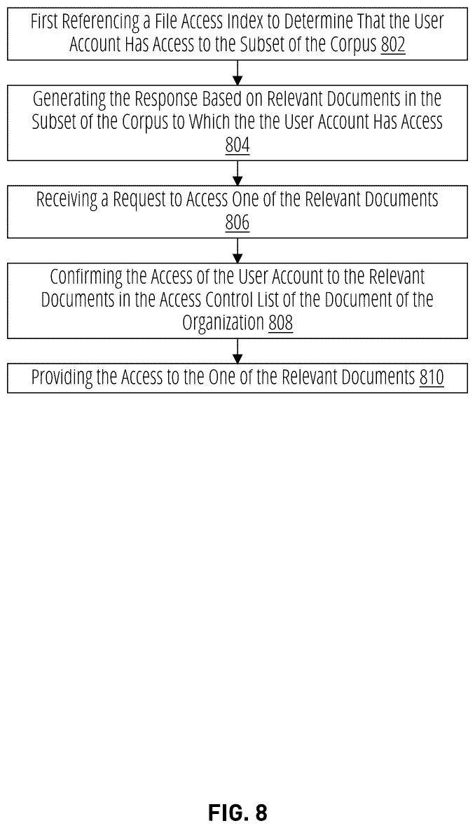

FIG. 8 illustrates an example routine for learning user accounts, roles within the organization, access to content items, and organizational vocabulary to create or update a content item access index in accordance with some aspects of the present technology. As with previous processes, the depicted sequence of operations may be altered without departing from the scope of this disclosure, and various components within a system may execute functions concurrently or in a specific sequence.

According to some examples, the method includes processing access rules and identity management information in an identity and access management system at block 802. The model may analyze access policies, user roles, and content item permissions to establish a structured access framework within the organization. Additionally, it may flag potential conflicts in access privileges, enhancing security oversight.

At block 804, the method includes creating a content item access index that compiles user accounts, their respective roles, associated teams, and a listing of content items accessible to each user. The model ensures that this index is continuously updated to reflect any changes in user permissions or organizational roles.

In some examples, the model can identify personnel and roles of personnel based on the content items. The model can track personnel mentioned in a content item (e.g., if a content item identifies a person as a project manager). The model can also identify personnel associated with content item metadata, such as an editor, contributor, author, commenter, viewer, or collaborator. In some aspects, generative response engine 110 can be provided with the organizational vocabulary and/or personnel information from organization server 140.

During pre-processing, generative response engine 110 can track content item permissions. For example, if generative response engine 110 is given access to content items in an organization's Google Drive, generative response engine 110 can track whether a user account is in a group that has permission to access a particular content item. In some examples, generative response engine 110 can build out a content item, graph (e.g., a node-edge graph), or other data structure that describes the content items in content item database 138 and which user accounts have access to a respective content item, or which groups have access to a respective content item and which user accounts are in each group. When generating a response to a prompt, generative response engine 110 can resolve the permissions of the requesting user account to determine which content items of content item database 138 can be used to generate a response to the prompt.

In addition to pre-processing content items of content item database 138, generative response engine 110 can pre-process organizational information (e.g., employees and their relationships, and organizational vocabulary) to generate a node-edge graph. For example, generative response engine 110 can extract relationships between user accounts and projects or products, and content items based on information in content item database 138 (e.g., if a content item describes an employee working on a particular product). Generative response engine 110 can generate a node-edge graph describing that employee's relationships with particular projects or products, content items, and organizational vocabulary within the organization, as well as with different employees (e.g., teammates, managers, etc.).

In some aspects, discrepancies may be detected between the user account's access privilege to a project and the content items they can access. In some aspects, generative response engine 110 can reason (generative response engine with reasoning capabilities) about whether the generative response engine should record that the user account has or does not have access to a content item or organizational vocabulary in content item access index 156. For example, a user account might have access to a project, but some content items within the project are not shared with the user account. Generative response engine 110 could reason that the user account should have access to the content item based on their access to the project by observing that the user account has access to lots of other content items pertaining to the project, or that the users that have access to the content item are often on content items that the user account can also access. All of this might indicate that the user account should have access. Conversely, if the content item is only shared with executive management, it might be more likely that the user account should not have access to the content item (assuming they are not part of executive management) even though they have access to the project. In another example, if the content item is describing the project, and the user account is the project manager of the project, their role would imply that they should have access to the content item.

In another example, the user account might have access to a content item that references a project that the user does not have access to. Generative response engine 110 can reason that this reference was an error and should not have been shared with the user account. Or, if the user account has access to most content items pertaining to the project, generative response engine 110 can reason that the user should have access to the project.

When such discrepancies are identified, generative response engine 110 can trigger a message to administrators of the organization. Or, if administrators of the organization have given generative response engine 110 authority to do so, generative response engine 110 can cause access permission changes.

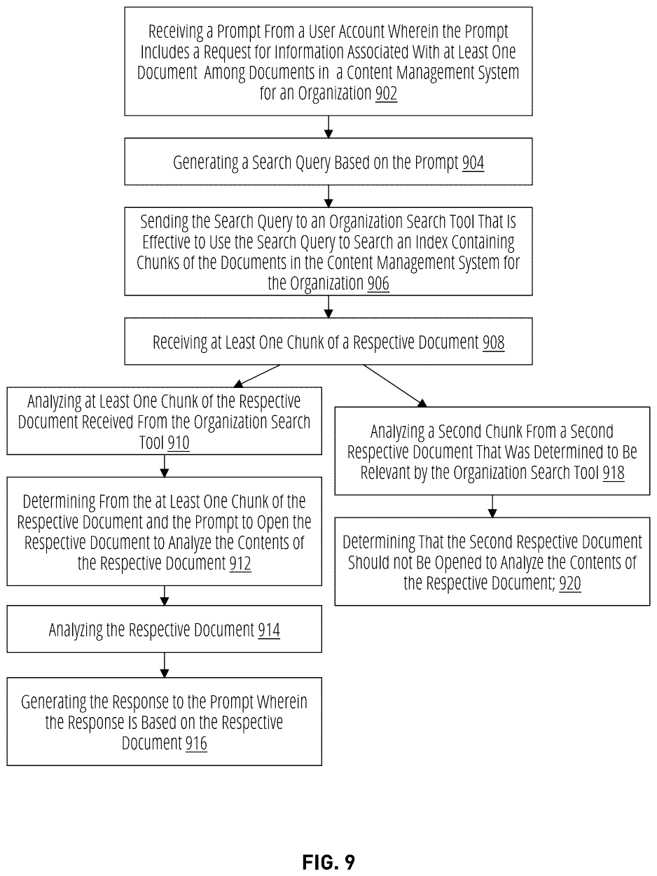

FIG. 9 illustrates an example routine for determining access privileges to a project for a user account in accordance with some aspects of the present technology. Although the example routine depicts a particular sequence of operations, the sequence may be altered without departing from the scope of this disclosure. For example, some operations may be performed in parallel or in a different sequence without materially affecting the function of the routine. Additionally, different components of an example device or system that implements the routine may execute functions concurrently or in a specific order.

In most of the examples provided above, generative response engine 110 does not need to explicitly know about access privileges since front end 102 or content item search tool 150 only provide information to generative response engine 110 that a user account is allowed to access. But in some aspects (such as described with respect to FIG. 9), generative response engine 110 can be trained to handle access determinations.

As part of its operation when generating a response to the prompt, generative response engine 110 needs to respect access privileges and policies of the organization. FIG. 9 addresses that generative response engine 110 respects access privileges and policies of the organization at a project level (organizational vocabulary) and at a content item level.

According to some examples, the method includes determining an access privilege of the user account to the project based on access data stored by an identity and access management server of the organization at block 902. For example, the generative response engine 110, illustrated in FIG. 1A, may retrieve access data from the identity and access management server or access organizational vocabulary index 154 to evaluate the user's permission level regarding the project. The project can be identified by a code name or other type of organizational vocabulary, and as addressed herein, some organizational vocabulary can be associated with user accounts or teams that have privileges to be aware of the project.

According to some examples, the method includes restricting the response to content accessible to the user account based on the access privilege of the user account for the project at block 904. Generative response engine 110 ensures that sensitive or unauthorized information remains inaccessible, complying with the organization's security policies. Therefore, even if a user account refers to a code name or other organizational vocabulary in a prompt, generative response engine 110 will respond referencing the code name in the context of the organization if the user account has privileges to be aware of the project related to the code name. If the user account does not have such privileges, generative response engine 110 will respond referring to the code name in its normal language meaning or refuse to answer the question if the prompt is clearly seeking information that the user account does not have access to.

According to some examples, the method includes determining, based on the access privilege of the user account for the project, that the user account has access to a subset of a corpus of content items associated with the project at block 906. Generative response engine 110 cross-references the user account's permissions with the relevant content item repository to ensure compliance with organizational access controls. For example, a user account might have privileges to know about a project related to a code name, but the user account might not have access to one or more content items referring to the project. Accordingly, generative response engine 110 can refer to content item index 152 to determine that a user account has access to content items that generative response engine 110 considers relevant to the prompt. If the user account does not have access, generative response engine 110 might not use the content items in generating the response.

According to some examples, the method includes restricting the response to be based on content items within the corpus of content items to which the user account has access at block 908. Generative response engine 110 dynamically filters out restricted content items (e.g., content items to which the user account does not have access), ensuring the integrity and confidentiality of organizational information.

In some aspects, discrepancies may arise between the user account's access privilege to the project (as determined at block 902) and the content items they can access (as determined at block 906). In some aspects, generative response engine 110 can reason (generative response engine with reasoning capabilities) about whether the generative response engine should prepare a response with context taken from those content items. For example, a user account might have access to a project, but some content items within the project are not shared with the user account. Generative response engine 110 could reason that the user account should have access to the content item based on their access to the project and by observing that the user account has access to lots of other content items pertaining to the project, or that the users that have access to the content item are often on content items that the user account can also access. All of this might indicate that the user account should have access. Conversely, if the content item is only shared with executive management, it might be more likely that the user account should not have access to the content item even though they have access to the project. In another example, if the content item is describing the project, and the user account is the project manager of the project, their role would imply that they should have access to the content item.

In another example, the user account might have access to a content item that references a project that the user does not have access to. Generative response engine 110 can reason that this reference was an error and should not have been shared with the user account. Or, if the user account has access to most content items pertaining to the project, generative response engine 110 can reason that the user should have access to the project.

When such discrepancies are identified, generative response engine 110 can trigger a message to administrators of the organization. Or, if administrators of the organization have given generative response engine 110 authority to do so, generative response engine 110 can cause access permission changes.

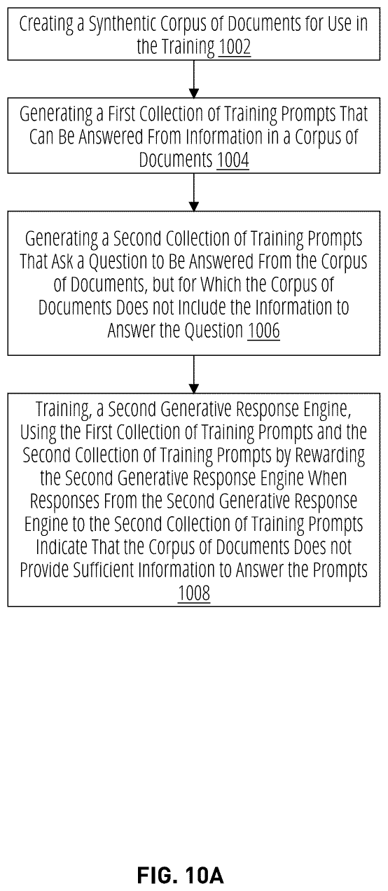

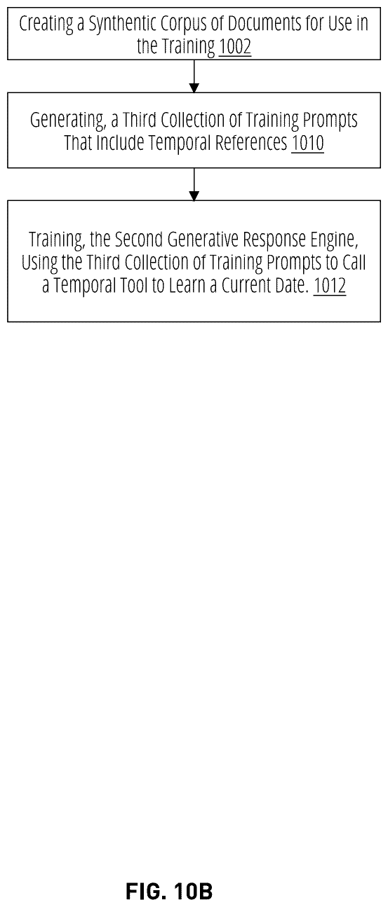

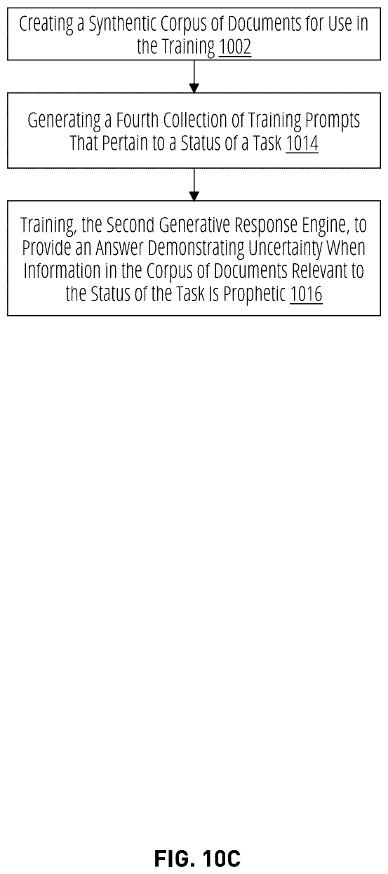

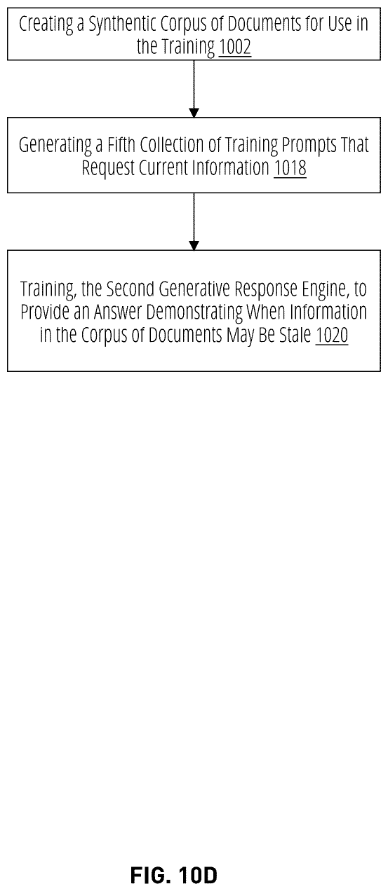

FIG. 10A, FIG. 10B, FIG. 10C, and FIG. 10D illustrate example routines for training the generative response engine. Although the example routines depict particular sequences of operations, the sequences may be altered without departing from the scope of the present disclosure. For example, some of the operations depicted may be performed in parallel or in a different sequence that does not materially affect the function of the respective routine. In other examples, different components of an example device or system that implements the routines may perform functions at substantially the same time or in a specific sequence.

In some examples, post-training can be based on a synthetic corpus of content items. Because the corpus of content items was synthetic, there were known gaps in subjects referenced in the content items. In other words, missing topics or subjects were known and thus training prompts that should result in refusal (e.g., prompts that reference a missing or absent topic) could be created and used to train generative response engine 110. This can prevent generative response engine 110 from providing an inaccurate or hallucinated response to the prompt.

Throughout the description of FIG. 10A, FIG. 10B, FIG. 10C, and FIG. 10D reference is made to the generative response engine and a second generative response engine. However, both can be the same generative response engine. That is the same generative response engine model can be used for all steps. The only distinction is that the second generative response engine ends up as a trained version of the generative response engine. Of course, both generative response engines can be different generative response engines. For example, one might be a larger, more capable model, or one might be a multi-modal model, while the other only capable of language inputs and outputs, or one might be a reasoning model, or one might be a distilled version of another model.

More important than which version of generative response engine is used for a particular step, is the fact that analyzing a content item or a chunk of a content item to answer a prompt is not a straightforward application of generative response engine technology. There are many instances in which a generative response engine might not provide an answer in the way it would be expected, and additional training for this purpose is required. Accordingly, FIG. 10A, FIG. 10B, FIG. 10C, and FIG. 10D provide just a few examples of scenarios in which generative response engines benefit from additional training to provide a quality user experience when generating responses in the context of a corpus of content items, especially those of an organization.

FIG. 10A pertains to post-training generative response engine 110 to learn to refuse to answer prompts for which generative response engine 110 cannot determine the answer from the corpus of content items.

According to some examples, the method includes creating a synthetic corpus of content items for use in the training at block 1002. For example, the generative response engine 110 illustrated in FIG. 1A may create a synthetic corpus of content items for use in the training.

According to some examples, the method includes generating a first collection of training prompts that can be answered from information in the synthetic corpus of content items at block 1004. For example, the generative response engine 110 illustrated in FIG. 1A may generate a first collection of training prompts that can be answered from information in the synthetic corpus of content items.

According to some examples, the method includes generating a second collection of training prompts that ask a question to be answered from the synthetic corpus of content items, but for which the synthetic corpus of content items does not include the information to answer the question at block 1006. For example, the generative response engine 110 illustrated in FIG. 1A may generate a second collection of training prompts that ask a question to be answered from the synthetic corpus of content items, but for which the synthetic corpus of content items does not include the information to answer the question.

According to some examples, the method includes training, a second generative response engine, using the first collection of training prompts and the second collection of training prompts by rewarding the second generative response engine when responses from the second generative response engine to the second collection of training prompts indicate that the synthetic corpus of content items does not provide sufficient information to answer the prompts at block 1008. For example, the generative response engine 110 illustrated in FIG. 1A may train, a second generative response engine, using the first collection of training prompts and the second collection of training prompts by rewarding the second generative response engine when responses from the second generative response engine to the second collection of training prompts indicate that the synthetic corpus of content items does not provide sufficient information to answer the prompts.

FIG. 10B pertains to post-training generative response engine 110 to understand some complexities associate with time referenced in prompts or content items. For example, a content item that says a project will be done in September should not be relied upon in October as proof that the project was completed. For example, generative response engine 110 might need to know the present date in order to respond to a prompt, and therefore generative response engine 110 can be trained to call a calendar or time tool to help it understand the current date with respect to dates in content items.

According to some examples, the method includes creating a synthetic corpus of content items for use in the training at block 1002. For example, the generative response engine 110 illustrated in FIG. 1A may create a synthetic corpus of content items for use in the training.

According to some examples, the method includes generating, a third collection of training prompts that include temporal references at block 1010. For example, the generative response engine 110 illustrated in FIG. 1A may generate, a third collection of training prompts that include temporal references. Training prompts containing temporal references can be, for example, prompts requesting a current, past, or future status of a project, prompts referencing a particular date, prompts requesting task completion time estimates, and the like.

According to some examples, the method includes training, the second generative response engine, using the third collection of training prompts to call a temporal tool to learn a current date at block 1012. For example, the generative response engine 110 illustrated in FIG. 1A may train, the second generative response engine, using the third collection of training prompts to call a temporal tool to learn a current date.

Related to complexities associated with time, FIG. 10C pertains to post-training generative response engine 110 to understand when some statements made in the past were prophetic and therefore are not evidence of fact. For example, a content item that says a project will be done in September should not be relied upon in October as proof that the project was completed. According to some examples, the method includes creating a synthetic corpus of content items for use in the training at block 1002. For example, the generative response engine 110 illustrated in FIG. 1A may create a synthetic corpus of content items for use in the training.

According to some examples, the method includes generating a fourth collection of training prompts that pertain to a status of a task at block 1014. For example, the generative response engine 110 illustrated in FIG. 1A may generate a fourth collection of training prompts that pertain to a status of a task.

According to some examples, the method includes training, the second generative response engine, to provide an answer demonstrating uncertainty when information in the synthetic corpus of content items relevant to the status of the task is prophetic at block 1016. For example, the generative response engine 110 illustrated in FIG. 1A may training, the second generative response engine, to provide an answer demonstrating uncertainty when information in the synthetic corpus of content items relevant to the status of the task is prophetic.

FIG. 10D pertains to the fact that information in content items can become stale, and FIG. 10D is a method for post-training 110 to determine that information is stale.

According to some examples, the method includes creating a synthetic corpus of content items for use in the training at block 1002. For example, the generative response engine 110 illustrated in FIG. 1A may create a synthetic corpus of content items for use in the training.

According to some examples, the method includes generating a fifth collection of training prompts that request current information at block 1018. For example, the generative response engine 110 illustrated in FIG. 1A may generate a fifth collection of training prompts that request current information.

According to some examples, the method includes training, the second generative response engine, to provide an answer demonstrating when information in the synthetic corpus of content items may be stale at block 1020. For example, the generative response engine 110 illustrated in FIG. 1A may training, the second generative response engine, to provide an answer demonstrating when information in the corpus of content items may be stale. The second generative response engine compares the current date from the temporal tool with a date (e.g., a creation date, version creation date, or a date of most recent update) associated with content items with relevant information in the synthetic corpus of content items.

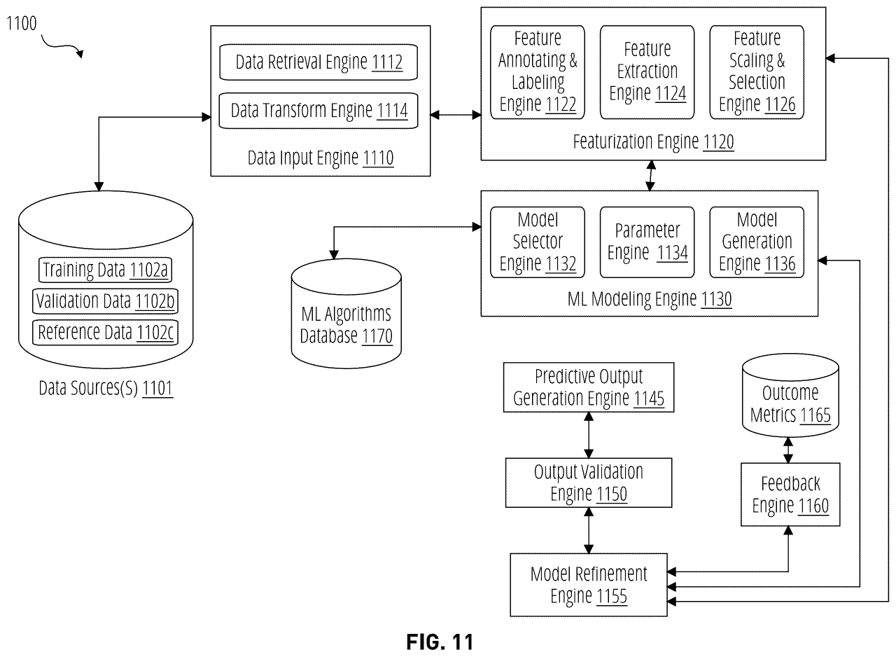

FIG. 11 is a block diagram illustrating an example machine learning platform for implementing various aspects of this disclosure in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

System 1100 may include data input engine 1110 that can further include data retrieval engine 1112 and data transform engine 1114. Data retrieval engine 1112 may be configured to access, interpret, request, or receive data, which may be adjusted, reformatted, or changed (e.g., to be interpretable by another engine, such as data input engine 1110). For example, data retrieval engine 1112 may request data from a remote source using an API. Data input engine 1110 may be configured to access, interpret, request, format, re-format, or receive input data from data sources(s) 1101. For example, data input engine 1110 may be configured to use data transform engine 1114 to execute a re-configuration or other change to data, such as a data dimension reduction. In some aspects, data sources(s) 1101 may be associated with a single entity (e.g., organization) or with multiple entities. Data sources(s) 1101 may include one or more of training data 1102a (e.g., input data to feed a machine learning model as part of one or more training processes), validation data 1102b (e.g., data against which at least one processor may compare model output with, such as to determine model output quality), and/or reference data 1102c. In some aspects, data input engine 1110 can be implemented using at least one computing device. For example, data from data sources(s) 1101 can be obtained through one or more I/O devices and/or network interfaces. Further, the data may be stored (e.g., during execution of one or more operations) in a suitable storage or system memory. Data input engine 1110 may also be configured to interact with a data storage, which may be implemented on a computing device that stores data in storage or system memory.

System 1100 may include featurization engine 1120. Featurization engine 1120 may include feature annotating & labeling engine 1122 (e.g., configured to annotate or label features from a model or data, which may be extracted by feature extraction engine 1124), feature extraction engine 1124 (e.g., configured to extract one or more features from a model or data), and/or feature scaling & selection engine 1126 Feature scaling & selection engine 1126 may be configured to determine, select, limit, constrain, concatenate, or define features (e.g., AI features) for use with AI models.

System 1100 may also include machine learning (ML) ML modeling engine 1130, which may be configured to execute one or more operations on a machine learning model (e.g., model training, model re-configuration, model validation, model testing), such as those described in the processes described herein. For example, ML modeling engine 1130 may execute an operation to train a machine learning model, such as adding, removing, or modifying a model parameter. Training of a machine learning model may be supervised, semi-supervised, or unsupervised. In some aspects, training of a machine learning model may include multiple epochs, or passes of data (e.g., training data 1102a) through a machine learning model process (e.g., a training process). In some aspects, different epochs may have different degrees of supervision (e.g., supervised, semi-supervised, or unsupervised). Data into a model to train the model may include input data (e.g., as described above) and/or data previously output from a model (e.g., forming a recursive learning feedback). A model parameter may include one or more of a seed value, a model node, a model layer, an algorithm, a function, a model connection (e.g., between other model parameters or between models), a model constraint, or any other digital component influencing the output of a model. A model connection may include or represent a relationship between model parameters and/or models, which may be dependent or interdependent, hierarchical, and/or static or dynamic. The combination and configuration of the model parameters and relationships between model parameters discussed herein are cognitively infeasible for the human mind to maintain or use. Without limiting the disclosed aspects in any way, a machine learning model may include millions, billions, or even trillions of model parameters. ML modeling engine 1130 may include model selector engine 1132 (e.g., configured to select a model from among a plurality of models, such as based on input data), parameter engine 1134 (e.g., configured to add, remove, and/or change one or more parameters of a model), and/or model generation engine 1136 (e.g., configured to generate one or more machine learning models, such as according to model input data, model output data, comparison data, and/or validation data).

In some aspects, model selector engine 1132 may be configured to receive input and/or transmit output to ML algorithms database 1170. Similarly, featurization engine 1120 can utilize storage or system memory for storing data and can utilize one or more I/O devices or network interfaces for transmitting or receiving data. ML algorithms database 1170 may store one or more machine learning models, any of which may be fully trained, partially trained, or untrained. A machine learning model may be or include, without limitation, one or more of (e.g., such as in the case of a metamodel) a statistical model, an algorithm, a neural network (NN), a convolutional neural network (CNN), a generative neural network (GNN), a Word2Vec model, a bag of words model, a term frequency-inverse content item frequency (tf-idf) model, a GPT (Generative Pre-trained Transformer) model (or other autoregressive model), a diffusion model, a diffusion-transformer model, an encoder such as BERT (Bidirectional Encoder Representations from Transformers) or LXMERT (Learning Cross-Modality Encoder Representations from Transformers), a Proximal Policy Optimization (PPO) model, a nearest neighbor model (e.g., k nearest neighbor model), a linear regression model, a k-means clustering model, a Q-Learning model, a Temporal Difference (TD) model, a Deep Adversarial Network model, or any other type of model described further herein. Some of the ML algorithms in ML algorithms database 1170 can be considered generative response engines. Generative response engines are those models are commonly referred to as Generative AI, and that can receive an input prompt and generate additional content based on the prompt. GPTs, diffusion models, and diffusion-transformer models are some non-limiting examples of generative response engines. Some specific examples of generative response engines that can be stored in the ML algorithms database 1170 include versions DALL·E, CHAT GPT, and SORA, all provided by OPEN AI.

System 1100 can further include predictive output generation engine 1145 and output validation engine 1150 (e.g., configured to apply validation data to machine learning model output). Predictive output generation engine 1145 can analyze the input and identify relevant patterns and associations in the data it has learned to generate a sequence of words that predictive output generation engine 1145 predicts is the most likely continuation of the input using one or more models from the ML algorithms database 1170, aiming to provide a coherent and contextually relevant answer. Predictive output generation engine 1145 generates responses by sampling from the probability distribution of possible words and sequences, guided by the patterns observed during its training. In some aspects, predictive output generation engine 1145 can generate multiple possible responses before presenting the final one. Predictive output generation engine 1145 can generate multiple responses based on the input, and these responses are variations that predictive output generation engine 1145 considers potentially relevant and coherent. Output validation engine 1150 can evaluate these generated responses based on certain criteria. These criteria can include relevance to the prompt, coherence, fluency, and sometimes adherence to specific guidelines or rules, depending on the application. Based on this evaluation, output validation engine 1150 selects the most appropriate response. This selection is typically the one that scores highest on the set criteria, balancing factors like relevance, informativeness, and coherence.

System 1100 can further include feedback engine 1160 (e.g., configured to apply feedback from a user and/or machine to a model) and model refinement engine 1155 (e.g., configured to update or re-configure a model). In some aspects, feedback engine 1160 may receive input and/or transmit output (e.g., output from a trained, partially trained, or untrained model) to outcome metrics database 1165. Outcome metrics database 1165 may be configured to store output from one or more models and may also be configured to associate output with one or more models. In some aspects, outcome metrics database 1165, or other device (e.g., model refinement engine 1155 or feedback engine 1160), may be configured to correlate output, detect trends in output data, and/or infer a change to input or model parameters to cause a particular model output or type of model output. In some aspects, model refinement engine 1155 may receive output from predictive output generation engine 1145 or output validation engine 1150. In some aspects, model refinement engine 1155 may transmit the received output to featurization engine 1120 or ML modeling engine 1130 in one or more iterative cycles.

The engines of system 1100 may be packaged functional hardware units designed for use with other components or a part of a program that performs a particular function (e.g., of related functions). Any or each of these modules may be implemented using a computing device. In some aspects, the functionality of system 1100 may be split across multiple computing devices to allow for distributed processing of the data, which may improve output speed and reduce computational load on individual devices. In some aspects, system 1100 may use load-balancing to maintain stable resource load (e.g., processing load, memory load, or bandwidth load) across multiple computing devices and to reduce the risk of a computing device or connection becoming overloaded. In these or other aspects, the different components may communicate over one or more I/O devices and/or network interfaces.

System 1100 can be related to different domains or fields of use. Descriptions of aspects related to specific domains, such as natural language processing or language modeling, is not intended to limit the disclosed aspects to those specific domains, and aspects consistent with the present disclosure can apply to any domain that utilizes predictive modeling based on available data.

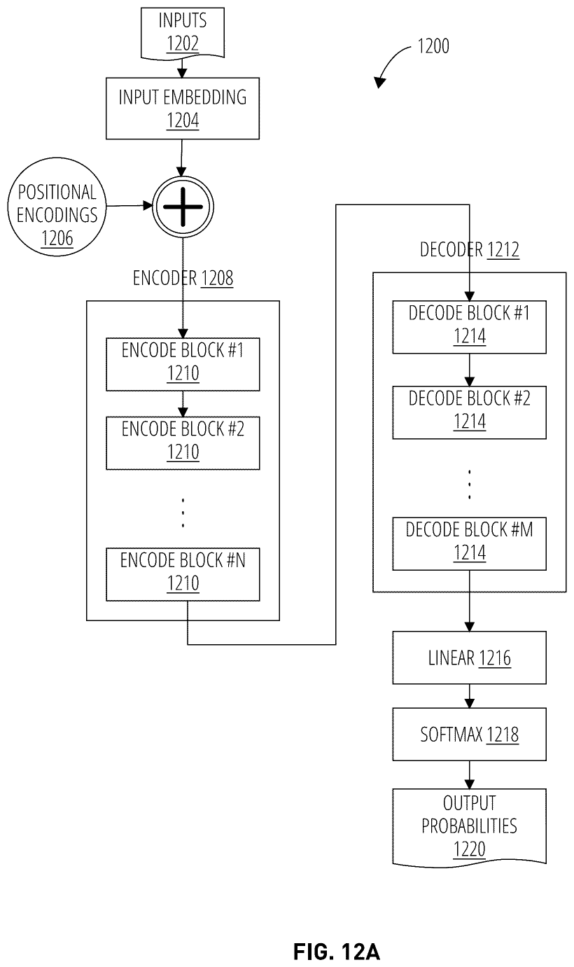

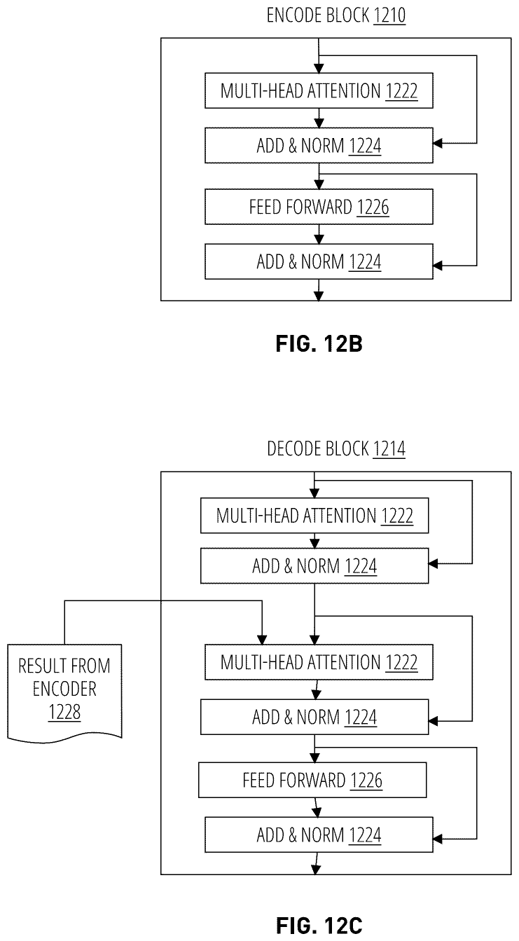

FIG. 12A, FIG. 12B, and FIG. 12C illustrates an example transformer architecture in accordance with some aspects of the present technology. Examples of ML models that use a transformer neural network (e.g., transformer architecture 1200) can include, e.g., generative pretrained transformer (GPT) models and Bidirectional Encoder Representations from Transformer (BERT) models. The transformer architecture 1200, which is illustrated in FIG. 12A, FIG. 12B, and FIG. 12C, includes inputs 1202, input embedding block 1204, positional encodings 1206, encoder 1208 including encode blocks 1210, decoder 1212 including decode blocks 1214, linear block 1216, softmax block 1218, and output probabilities 1220.

Input embedding block 1204 is used to provide representations for words. For example, embedding can be used in text analysis. According to certain non-limiting examples, the representation is a real-valued vector that encodes the meaning of the word in such a way that words that are closer in the vector space are expected to be similar in meaning. Word embeddings can be obtained using language modeling and feature learning techniques, where words or phrases from the vocabulary are mapped to vectors of real numbers. According to certain non-limiting examples, the input embedding block 1204 can be learned embeddings to convert the input tokens and output tokens to vectors of dimension that have the same dimension as the positional encodings, for example.

Positional encodings 1206 provide information about the relative or absolute position of the tokens in the sequence. According to certain non-limiting examples, positional encodings 1206 can be provided by adding positional encodings to the input embeddings at the inputs to the encoder 1208 and decoder 1212. The positional encodings have the same dimension as the embeddings, thereby enabling a summing of the embeddings with the positional encodings. There are several ways to realize the positional encodings, including learned and fixed. For example, sine and cosine functions having different frequencies can be used. That is, each dimension of the positional encoding corresponds to a sinusoid. Other techniques of conveying positional information can also be used, as would be understood by a person of ordinary skill in the art. For example, learned positional embeddings can instead be used to obtain similar results. An advantage of using sinusoidal positional encodings rather than learned positional encodings is that doing so allows the model to extrapolate to sequence lengths longer than the ones encountered during training.

Encoder 1208 can use stacked self-attention and point-wise, fully connected layers. Encoder 1208 can be a stack of N identical layers (e.g., N=6), and each layer can be an encode block, as illustrated by encode block 1210 shown in FIG. 12B. Each encode block 1210 has two sub-layers: (i) a first sub-layer has a multi-head attention block 1222 and (ii) a second sub-layer has a feed forward block 1226, which can be a position-wise fully connected feed-forward network. The feed forward block 1226 can use a rectified linear unit (ReLU).

Encoder 1208 uses a residual connection around each of the two sub-layers, followed by an add & norm block 1224, which performs normalization. For example, the output of each sub-layer can be LayerNorm(x+Sublayer(x)). To facilitate these residual connections, all sub-layers in the model, as well as the embedding layers, produce output data having a same dimension.

Similar to encoder 1208, decoder 1212 uses stacked self-attention and point-wise, fully connected layers. Decoder 1212 can also be a stack of M identical layers (e.g., M=6), and each layer can be a decode block, as illustrated by decode block 1212 shown in FIG. 12B. In addition to the two sub-layers (i.e., the sublayer with multi-head attention block 1222 and the sub-layer with feed forward block 1226) found in encode block 1210, decode block 1214 can include a third sub-layer, which performs multi-head attention over the output of the encoder stack. Similar to encoder 1208, decoder 1212 uses residual connections around each of the sub-layers, followed by layer normalization. Additionally, the sub-layer with multi-head attention block 1222 can be modified in the decoder stack to prevent positions from attending to subsequent positions. This masking, combined with the fact that the output embeddings are offset by one position, can ensure that the predictions for position i can depend only on the known output data at positions less than i.

Linear block 1216 can be a learned linear transformation. For example, when transformer architecture 1200 is being used to translate from a first language into a second language, linear block 1216 can project the output from the last decode softmax block 1218 into word scores for the second language (e.g., a score value for each unique word in the target vocabulary) at each position in the sentence. For instance, if the output sentence has seven words and the provided vocabulary for the second language has 10,000 unique words, then 10,000 score values are generated for each of those seven words. The score values indicate the likelihood of occurrence for each word in the vocabulary in that position of the sentence.

Softmax block 1218 then turns the scores from linear block 1216 into output probabilities 1220 (which add up to 1.0). In each position, the index provides for the word with the highest probability, and then maps that index to the corresponding word in the vocabulary. Those words then form the output sequence of transformer architecture 1200. The softmax operation is applied to the output from linear block 1216 to convert the raw numbers into output probabilities 1220 (e.g., token probabilities).

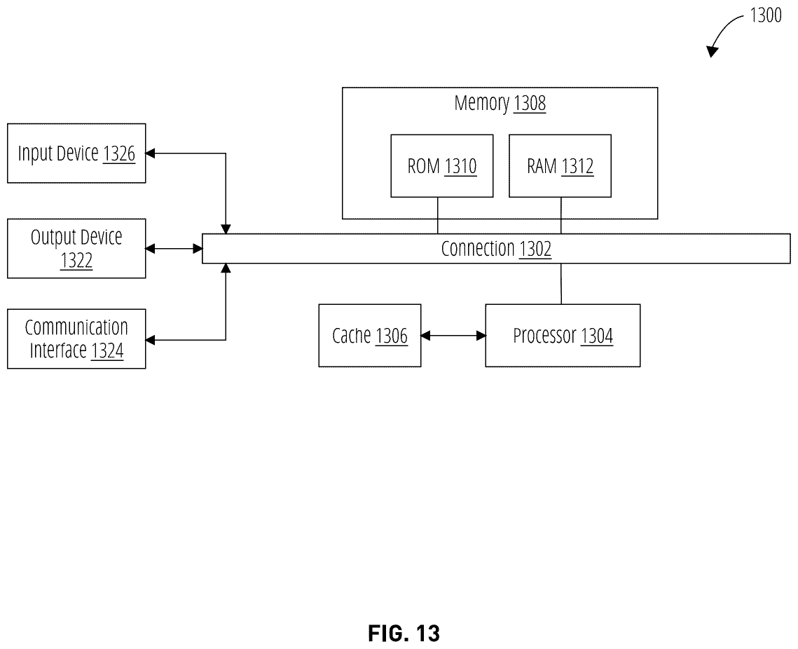

FIG. 13 shows an example of computing system 1300, which can be, for example, any computing device making up any engine illustrated in FIG. 1A or any component thereof.

In some aspects, computing system 1300 is a single device, or a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

In some aspects, computing system 1300 may comprise one or more computing resources provisioned from a “cloud computing” provider, For example, AMAZON ELASTIC COMPUTE CLOUD (“AMAZON EC2”), provided by AMAZON, INC. of Seattle, Washington; SUN CLOUD COMPUTER UTILITY, provided by SUN MICROSYSTEMS, INC. of Santa Clara, California; AZURE, provided by MICROSOFT CORPORATION of Redmond, Washington, GOOGLE CLOUD PLATFORM, provided by ALPHABET, INC. of Mountain View, California, and the like.

Example computing system 1300 includes at least one processing unit (CPU or processor) 1304 and connection 1302 that couples various system components including system memory 1308, such as read-only memory (ROM) 1310 and random access memory (RAM) 1312 to processor 1304. Memory 1308 can be a volatile or non-volatile memory device, and can be a hard disk or other types of non-transitory computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

Memory 1308 can include software services, servers, logic, etc., that when the code that defines such software is executed by the processor 1304, it causes the system to perform a function. In some aspects, a hardware service that performs a particular function can include the software component stored in a computer-readable medium in connection with the necessary hardware components, such as processor 1304, connection 1302, output device 1322, etc., to carry out the function.

Computing system 1300 can include a cache of high-speed memory 1306 connected directly with, in close proximity to, or integrated as part of processor 1304.

Connection 1302 can be a physical connection via a bus, or a direct connection into processor 1304, such as in a chipset architecture. Connection 1302 can also be a virtual connection, networked connection, or logical connection.

Processor 1304 can include any general purpose processor and a hardware service or software service stored in memory 1308, configured to control processor 1304 as well as a special-purpose processor where software instructions are incorporated into the actual processor design. Processor 1304 may essentially be a completely self-contained computing system, containing multiple cores or processors, a bus, memory controller, cache, etc. A multi-core processor may be symmetric or asymmetric. Processor 1304 can be physical or virtual.

To enable user interaction, computing system 1300 includes an input device 1326, which can represent any number of input mechanisms, such as a microphone for speech, a touch-sensitive screen for gesture or graphical input, keyboard, mouse, motion input, speech, etc. Computing system 1300 can also include output device 1322, which can be one or more of a number of output mechanisms known to those of skill in the art. In some instances, multimodal systems can enable a user to provide multiple types of input/output to communicate with computing system 1300. Computing system 1300 can include communication interface 1324, which can generally govern and manage the user input and system output. There is no restriction on operating on any particular hardware arrangement, and therefore the basic features here may easily be substituted for improved hardware or firmware arrangements as they are developed.

In some aspects, computing system 1300 can refer to a combination of a personal computing device interacting with components hosted in a data center, where both the computing device and the components in the data center. In such examples, both the personal computing device and the components in the datacenter might have a processor, cache, memory, storage, etc.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some aspects, a service can be software that resides in memory of a client device and/or one or more servers of a content management system and perform one or more functions when a processor executes the software associated with the service. In some aspects, a service is a program or a collection of programs that carry out a specific function. In some aspects, a service can be considered a server. The memory can be a non-transitory computer-readable medium.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

### Aspects

The present technology includes computer-readable storage mediums for storing instructions, and systems for executing any one of the methods embodied in the instructions addressed in the Aspects of the present technology presented below:

Aspect 1: A method comprising: receiving, by a generative response engine, a prompt from a user account referencing a term that is a code name within an organization and the term has a different meaning outside of the organization other than the code name, wherein the user account is associated with the organization and wherein the prompt includes a request for information associated with a project having the code name; generating, by the generative response engine, a response to the prompt, wherein the response reflects the code name meaning of the term, wherein a portion of content of the response is based on a corpus of content items specific to the organization; and providing, by a front end to the generative response engine, the response to the user account wherein the response reflects the code name meaning of the term.

Aspect 2: The method of aspect 1, the method comprising: prior to the receiving the prompt by the generative response engine, receiving the prompt by a front end; searching words in the prompt against an organizational vocabulary index to identify the code name in the prompt; determining that the user account that provided the prompt is authorized for the code name; and providing an identification of the code name to the generative response engine.

Aspect 3: The method of any one of aspects 1-2, wherein the providing the identification of the code name to the generative response engine also includes providing a meaning of the code name.

Aspect 4: The method of any one of aspects 1-3, further comprising: prior to receiving the prompt from the user account, generating an organizational vocabulary index, wherein the organizational vocabulary index includes terminology specific to the organization and includes the code name.

Aspect 5: The method of any one of aspects 1-4, wherein generating the organizational vocabulary index further comprises: processing the corpus of content items specific to the organization to identify terms within the corpus of content items that are code names within the organization; recording respective code names and content item identifiers of content items within the corpus of content items in which the code names are present into the organizational vocabulary index.

Aspect 6: The method of any one of aspects 1-5, further comprising: recording user accounts that have access to respective terms within the organizational vocabulary index.

Aspect 7: The method of any one of aspects 1-6, wherein the generative response engine is trained to disambiguate a meaning of the term within the organization.

Aspect 8: The method of any one of aspects 1-7, further comprising: processing, by the generative response engine, access rules and identity management information in an identity and access management system of the organization to identify user accounts, roles, and access information; and creating a content item access index including the user accounts and respective roles, teams, and a listing of content items and terms to which the user account has access.

Aspect 9: The method of any one of aspects 1-8, wherein the processing of the access rules and identity management information involves reasoning over access rules and access control lists associated with content items to identify potentially conflicting access privileges.

Aspect 10: The method of any one of aspects 1-9, wherein the response to the prompt is generated based, in part, on a role of the user account within the organization, wherein the role can be used to determine a character of the response, wherein the character of the response can include content of the response, a level of detail of the response, or a tone of the response.

Aspect 11: The method of any one of aspects 1-10, further comprising: determining an access privilege of the user account to the project referenced by the code name; and restricting the response to content accessible to the user account based on the access privilege of the user account for the project referenced by the code name.

Aspect 12: The method of any one of aspects 1-11, further comprising: determining, based on the access privilege of the user account for the project, that the user account has access to a subset of the corpus of content items associated with the project; and restricting, by the generative response engine, the response to be based on content items within the subset of the corpus of content items to which the user account has access.

Aspect 13: The method of any one of aspects 1-12, wherein the determining that the user account has access to the subset of the corpus of the content items associated with the project comprises: referencing a content item access index to determine that the user account has access to the subset of the corpus of content items; generating the response based on relevant content items in the subset of the corpus of content items to which the user account has access; receiving a request to access one of the relevant content items; prior to granting the access to the one of the relevant content items, confirming access of the user account to the relevant content items in an access control list of the content item of the organization; and when the access of the user account is confirmed, providing the access to the one of the relevant content items.

Aspect 14: The method of any one of aspects 1-13, wherein the disambiguation of the term further comprises: determining, by the generative response engine, to access the organizational vocabulary index when the generative response engine crosses a decision boundary, wherein the generative response engine was post-trained to differentiate when the term is used in context of the different meaning outside of the organization and the code name.

Aspect 15: The method of any one of aspects 1-14, further comprising: identifying, by the generative response engine, a subset of content items of the corpus of content items that pertain to the project; determining, by the generative response engine, a current status of the project, based in part, on an age of respective content items of the subset of content items; and including, by the generative response engine, the current status of the project in the response.

Aspect 16: The method of any one of aspects 1-15, wherein determining the current status of the project comprises: for a respective content item: identifying a milestone date in content of the respective content item; and comparing the milestone date with the age of the respective content item to determine whether the milestone date is associated with the current status of the project.

Aspect 17: The method of any one of aspects 1-16, further comprising: determining, based on ages of respective content items in the subset of content items, that content of the subset of content items is stale; and including, by the generative response engine, an indication that the current status of the project is stale in the response.

Aspect 18: A method comprising: receiving, by a generative response engine, a prompt from a user account wherein the prompt includes a request for information associated with at least one content item among content items in a content management system for an organization; generating, by the generative response engine, a search query based on the prompt; sending, by the generative response engine, the search query to an organization search tool that is effective to use the search query to search an index containing chunks of the content items of the organization; receiving, by the generative response engine, at least one chunk of a respective content item, wherein the at least one chunk was determined to be relevant by the organization search tool; generating, by the generative response engine, a response to the prompt that is based, at least in part, one at least one chunk of the respective content item received from the organization search tool.

Aspect 19: The method of aspect 18, further comprising: determining, by the organization search tool, that the user account is authorized to access the respective content item from which the at least chunk is sourced; and when the user account is authorized to access the respective content item, sending the at least one chunk to the content management system.

Aspect 20: The method of any one of aspects 18-19, further comprising: determining, by the generative response engine, from the at least one chunk of the respective content item and the prompt to open the respective content item to analyze contents of the respective content item beyond the at least one chunk; and analyzing, by the generative response engine, the respective content item; and generating, by the generative response engine, the response to the prompt wherein at least a portion of the response is based on the respective content item.

Aspect 21: The method of any one of aspects 18-20, further comprising: analyzing, by the generative response engine, a second chunk from a second respective content item that was determined to be relevant by the organization search tool; and determining, by the generative response engine, that the second respective content item does should not be opened to analyze the contents of the respective content item; and wherein the response to the prompt is based on the second chunk from the second respective content item.

Aspect 22: The method of any one of aspects 18-21, wherein the generative response engine was post-trained on labelled training data indicating when or when not to open a content item.

Aspect 23: The method of any one of aspects 18-22, wherein the determining to open the respective content item is a result of the generative response engine crossing a decision boundary.

Aspect 24: The method of any one of aspects 18-23, wherein the prompt references a term that is a code name within an organization and the term has a different meaning outside of the organization other than the code name, and wherein the response to the prompt reflects the code name meaning of the term.

Aspect 25: The method of any one of aspects 18-24, further comprising: determining, by the generative response engine, that an adequate response to the prompt cannot be provided based on the information in the at least one chunk of the respective content item received from the organization search tool, and wherein the response is a message informing the user account that an adequate response cannot be generated.

Aspect 26: The method of any one of aspects 18-25, wherein the prompt request a current status of a project references in the content items of the organization, the method further comprising: for a respective content item, identifying a milestone date in content of the respective content item; comparing the milestone date with the age of the respective content item to determine whether the milestone date is associated with the current status of the project; determining, based on age of the respective content item, that content is stale; and including, by the generative response engine, an indication that the current status of the project is stale in the response.

Aspect 27: A method comprising: generating, by a generative response engine, a first collection of training prompts that can be answered from information in a corpus of content items; generating, by the generative response engine, a second collection of training prompts that ask a question to be answered from the corpus of content items, but for which the corpus of content items does not include the information to answer the question; training, a second generative response engine, using the first collection of training prompts and the second collection of training prompts by rewarding the second generative response engine when responses from the second generative response engine to the second collection of training prompts indicate that the corpus of content items does not provide sufficient information to answer the prompts.

Aspect 28: The method of aspect 27, further comprising: generating, a third collection of training prompts that include temporal references; training, the second generative response engine, using the third collection of training prompts to call a temporal tool to learn a current date.

Aspect 29: The method of any one of aspects 27-28, further comprising: generating a fourth collection of training prompts that pertain to a status of a task; training, the second generative response engine, to provide an answer demonstrating uncertainty when information in the corpus of content items relevant to the status of the task is prophetic.

Aspect 30: The method of any one of aspects 27-29, further comprising: generating a fifth collection of training prompts that request current information; training, the second generative response engine, to provide an answer demonstrating when information in a corpus of content items may be stale, wherein the second generative response engine compares the current date from the temporal tool with a date associated with content items with relevant information in the corpus of content items.

Aspect 31: The method of any one of aspects 27-30, further comprising: creating a synthetic corpus of content items for use in the training.

Any of the groups of aspects can be used together. For example, any of aspects recited in Aspects 1-17, 18-26, and 27-30 can be used together.

What is claimed is:

1. A method comprising:
receiving, by a generative response engine, a prompt from a user account referencing a term that is a code name within an organization and the term has a different meaning outside of the organization other than the code name, wherein the user account is associated with the organization and wherein the prompt includes a request for information associated with a project having the code name;
generating, by the generative response engine, a response to the prompt, wherein the response reflects a code name meaning of the term; and
providing, by a front end to the generative response engine, the response to the user account wherein the response reflects the code name meaning of the term.

2. The method of claim 1, the method comprising:
prior to receiving the prompt by the generative response engine, receiving the prompt by a front end;
searching words in the prompt against an organizational vocabulary index to identify the code name in the prompt;
determining that the user account that provided the prompt is authorized for the code name; and
providing an identification of the code name to the generative response engine.

3. The method of claim 2, wherein providing the identification of the code name to the generative response engine also includes providing a meaning of the code name.

4. The method of claim 1, further comprising:
prior to receiving the prompt from the user account, generating an organizational vocabulary index, wherein the organizational vocabulary index includes terminology specific to the organization and includes the code name.

5. The method of claim 4, wherein generating the organizational vocabulary index further comprises:
processing a corpus of content items specific to the organization to identify terms within the corpus of content items that are code names within the organization; and
recording respective code names and content item identifiers of content items within the corpus of content items in which the code names are present into the organizational vocabulary index.

6. The method of claim 5, further comprising:
recording user accounts that have access to respective terms within the organizational vocabulary index.

7. The method of claim 1, further comprising:
determining an access privilege of the user account to the project referenced by the code name; and
restricting the response to content accessible to the user account based on the access privilege of the user account for the project referenced by the code name.

8. The method of claim 7, wherein determining that the user account has access to a subset of a corpus of the content items associated with the code name comprises:
referencing a content item access index to determine that the user account has access to the subset of the corpus of content items; and
generating the response based on relevant content items in the subset of the corpus of content items to which the user account has access.

9. A computing system comprising:
at least one processor; and
a memory storing instructions that, when executed by the at least one processor, configure the computing system to:
receive, by a generative response engine, a prompt from a user account referencing a term that is a code name within an organization and the term has a different meaning outside of the organization other than the code name, wherein the user account is associated with the organization and wherein the prompt includes a request for information associated with a project having the code name;
generate, by the generative response engine, a response to the prompt, wherein the response reflects a code name meaning of the term; and
provide, by a front end to the generative response engine, the response to the user account wherein the response reflects the code name meaning of the term.

10. The computing system of claim 9, wherein the instructions further configure the computing system to:
prior to receiving the prompt by the generative response engine, receive the prompt by a front end;
search words in the prompt against an organizational vocabulary index to identify the code name in the prompt;
determine that the user account that provided the prompt is authorized for the code name; and
provide an identification of the code name to the generative response engine.

11. The computing system of claim 10, wherein providing the identification of the code name to the generative response engine also includes provide a meaning of the code name.

12. The computing system of claim 9, wherein the instructions further configure the computing system to:
prior to receiving the prompt from the user account, generate an organizational vocabulary index, wherein the organizational vocabulary index includes terminology specific to the organization and includes the code name.

13. The computing system of claim 12, wherein generating the organizational vocabulary index further comprises:
process a corpus of content items specific to the organization to identify terms within the corpus of content items that are code names within the organization; and
record respective code names and content item identifiers of content items within the corpus of content items in which the code names are present into the organizational vocabulary index.

14. The computing system of claim 13, wherein the instructions further configure the computing system to:
record user accounts that have access to respective terms within the organizational vocabulary index.

15. The computing system of claim 9, wherein the instructions further configure the computing system to:
determine an access privilege of the user account to the project referenced by the code name; and
restrict the response to content accessible to the user account based on the access privilege of the user account for the project referenced by the code name.

16. A non-transitory computer-readable storage medium comprising instructions that when executed by at least one processor, cause the at least one processor to:
receive, by a generative response engine, a prompt from a user account referencing a term that is a code name within an organization and the term has a different meaning outside of the organization other than the code name, wherein the user account is associated with the organization and wherein the prompt includes a request for information associated with a project having the code name;
generate, by the generative response engine, a response to the prompt, wherein the response reflects a code name meaning of the term; and
provide, by a front end to the generative response engine, the response to the user account wherein the response reflects the code name meaning of the term.

17. The non-transitory computer-readable storage medium of claim 16, wherein the instructions further configure the at least one processor to:
prior to receipt of the prompt by the generative response engine, receiving the prompt by a front end;
search words in the prompt against an organizational vocabulary index to identify the code name in the prompt;
determine that the user account that provided the prompt is authorized for the code name; and
provide an identification of the code name to the generative response engine.

18. The non-transitory computer-readable storage medium of claim 17, wherein providing the identification of the code name to the generative response engine also includes provide a meaning of the code name.

19. The non-transitory computer-readable storage medium of claim 16, wherein the instructions further configure the at least one processor to:
determine an access privilege of the user account to the project referenced by the code name; and
restrict the response to content accessible to the user account based on the access privilege of the user account for the project referenced by the code name.

20. The non-transitory computer-readable storage medium of claim 19, wherein determining that the user account has access to a subset of a corpus of the content items associated with the code name comprises:
reference a content item access index to determine that the user account has access to the subset of the corpus of content items; and
generate the response based on relevant content items in the subset of the corpus of content items to which the user account has access.
